(19) United States
(12) Patent Application Publication
(10) Pub. No.: US 2010/0158966 A1
(43) Pub. Date: Jun. 24, 2010

(54) SELENIUM-BASED BIOCIDAL FORMULATIONS AND METHODS OF USE THEREOF

(76) Inventors: Ted Reid, Lubbock, TX (US); Julian Spallholz, Lubbock, TX (US)

Correspondence Address: DUNLAP CODDING, P.C., PO BOX 16370, OKLAHOMA CITY, OK, 73113, US

(21) Appl. No.: 12/699,440

(22) Filed: Feb. 3, 2010

Related U.S. Application Data
(63) Continuation-in-part of application No. 11/439,751, filed on May 24, 2006.
(60) Provisional application No. 60/683,847, filed on May 24, 2005.
(60) Provisional application No. 60/730,335, filed on Oct. 26, 2005.
(60) Provisional application No. 60/802,670, filed on May 23, 2006.
(60) Provisional application No. 61/149,658, filed on Feb. 3, 2009.
(60) Provisional application No. 61/149,650, filed on Feb. 3, 2009.

(51) Int. Cl. A01N 25/34; A01N 55/02

(52) U.S. Cl. 424/411; 514/492

(57) ABSTRACT

Biocidal formulations that include a selenium compound selected from the group consisting of RSeH, RSeR′, RSeSeR, RseSeR′, and RseX, wherein each of R and R′ include an aliphatic or phenolic residue, and wherein X is a protecting group selected from the group consisting of a halogen, an imide, a cyanide, an azide, a phosphate, a sulfate, a nitrate, a carbonate, selenium dioxide, and combinations thereof, are provided. The selenium compounds may be incorporated into an acrylate polymer matrix, or may be incorporated into a molten plastic material. Methods for preventing growth of a species of interest on an object or in a composition are also provided.

### CROSS REFERENCE TO RELATED APPLICATIONS

This application claims benefit under 35 U.S.C. 119(e) of provisional applications U.S. Ser. No. 61/149,658, filed Feb. 3, 2009; and U.S. Ser. No. 61/149,650, filed Feb. 3, 2009. This application is also a continuation-in-part of U.S. Ser. No. 11/439,751, filed May 24, 2006; which claims benefit under 35 U.S.C. 119(e) of provisional applications U.S. Ser. No. 60/683,847, filed May 24, 2005; U.S. Ser. No. 60/730,335, filed Oct. 26, 2005; and U.S. Ser. No. 60/802,670, filed May 23, 2006. The entire contents of each of the above-referenced patents and patent applications are hereby expressly incorporated herein by reference.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to biocidal formulations that utilize free radical generation as a mechanism of toxicity, and more specifically, to selenium-based formulations that utilize free radical generation as a mechanism of toxicity.

2. Description of the Background Art

Selenium (Se) is among the most toxic of all known minerals. Its toxicity symptoms in horses were most likely described by Marco Polo while traveling the Silk Road in China. In the 1920's, loss of livestock in parts of the western and central United States was severe. Those losses of livestock were investigated by the United States Department of Agriculture Experiment Station in South Dakota. In 1934, the cause of the loss of livestock was traced by the Experiment Station to the element selenium which was high in certain soils and high secondarily in plants from several species of Astragalus (vetch), Xylorrhiza (woody aster), Conopsis (goldenrod) and Stanleya (Prince's Plume). Ingestion of these and other Se containing plants by livestock often proved to be fatal.

Throughout the period of time between the discovery of selenium toxicity in livestock in 1934 and 1988, many hypotheses were put forth to explain the mechanism by which many but not all compounds of selenium were toxic. None of these theories of selenium toxicity proved satisfactory in fully explaining why selenium was toxic. In 1989, Seko et al. (In: Proceedings of the fourth international symposium on selenium and medicine (ed., Wendel, A.) pp. 70-73, Springer-Verlag, Heidelberg, Germany, (1989)), reported that selenite, (SeO₃), an inorganic form of Se, reacted with a thiol, glutathione, (GSH), to produce superoxide (O₂⁻). Since superoxide is a known toxicant, this raised the possibility that all selenium compounds that are toxic might generate superoxide. Through the testing of many selenium compounds, it was found that the inorganic compounds, SeO₃ and selenium dioxide (SeO₂) were able to generate O₂⁻ and hydrogen peroxide (H₂O₂) when presented with a thiol, such as glutathione, cysteine (CysSH), or dithiothreitol D(SH)₂. Furthermore, it was found that all diselenides tested of the composition RSeSeR likewise would generate O₂⁻ and H₂O₂ when presented with any of the before mentioned thiols.

In 1947, Feigl et al. (Analytical Chemistry, 19:351-353 (1947)), reported that selenium could catalyze a redox reaction involving sulfide oxidation. This soon became a common test for selenium using methylene blue. This reaction was further studied by others using different selenium compounds and thiols, demonstrating catalysis for some but not all selenium compounds. See, West et al. (Analytic Chemistry, 40:966-968 (1968)); Levander et al. (Biochemistry, 12:4591-4595 (1973)), Rhead et al. (Bioorganic Chemistry, 3:225-242 (1974)). The selenium catalytic activity of selenocystine (RSeSeR) in the presence of thiols was reported in 1958. It is now believed that all of the foregoing reactions of selenium compounds produce superoxide. See, Xu et al. (Advances in Free Radical Biology and Medicine, 1:35-48 (1991)); Xu et al. (Huzahong Longong Daxus Xuebao, 19:13-19 (1991)); Kitahara et al. (Archives of toxicology, 67:.497-501 (1993)); Chaudiere et al. (Archives of Biochemistry and Biophysics, 296:328-336 (1992)).

Selenium and a number of its compounds have been known since the early 1970's to possess anti-cancer properties. It has been generally recognized that selenite and selenium dioxide are good anti-cancer agents in vitro and in experimental animals and that the compounds are also cytotoxic to both cancer and normal cells in vitro. U.S. Pat. No. 5,104,852 issued to Kralick et al. describes the use of selenodiglutathione (GSSeSG) and other selenodithiols of the configuration (RSSeSR) to treat cancer. Selenodiglutathione is the product of the reaction between selenite or selenium dioxide with glutathione. The compound, selenodiglutathione, has been isolated. U.S. Pat. No. 5,104,852, however, does not describe the mechanism of action by which selenodiglutathione and like compounds are useful in treating cancer.

In 1982, the interaction of selenite and selenocystine with glutathione in the cytotoxicity and lysis of rat erythrocyte membranes was described by Hu et al. (Biochemical Pharmacology, 32:857-961 (1983)). This cytotoxicity, as revealed by scanning electron microscopy of rat erythrocytes, caused the erythrocyte membranes to become burred, the cells to quadruple in size and lyse similar to that described by Kellogg et al. (J. Biol. Chem., 252:6721-6728 (1977)). This toxicity, however, was not expressed by selenomethionine, a compound possessing the configuration RSeCH₃. In 1991, an article by Yan et al. (FASEB J., 5:A581 (1991)), showed a dose responsive toxicity of several selenium compounds to a human mammary tumor cell line. Additional investigations using lucigenin chemiluminescence and luminol chemiluminescence revealed a dose response in O₂⁻ and H₂O₂ generated chemiluminescence by selenite, selenium dioxide and all selenium compounds tested of the configuration RSeSeR. Furthermore, it was found that selenium compounds in the presence of either tumor cells or glutathione alone produced superoxide and H₂O₂. Chemiluminescence from the reactions of lucigenin with O₂⁻ or luminol with H₂O₂ could be quenched by the native enzymes superoxide dismutase (SOD), catalase (CT) or glutathione peroxidase (GSHPx). Denatured enzymes would not quench these reactions, confirming the generation of the free radical (O₂⁻) and H₂O₂ by selenium compounds and thiols. All of this selenium free radical chemistry has been reviewed by Spallholz (Free Radical Biology and Medicine, 17:45-64, (1994)).

A summation of this large body of experimental data on selenium toxicity, catalysis and carcinostatic activity is as follows:
1) The selenium compounds, SeO₂ and SeO₃, react with thiols to produce a selenodithiol of the configuration (RSSeSR). This compound is not toxic per se nor is it carcinostatic. The toxic carcinostatic form of RSSeSR is the reduced selenide anion, RSSe⁻. This selenopersulfide form of Se is catalytic as shown by the inhibition of both catalysis and superoxide generation by iodoacetic acid and mercaptosuccinic acid.
2) Selenium compounds of the configuration (RSeSeR) or (RSeSeR′) react with thiols to produce the reduced selenite anion RSe⁻ or R′Se⁻. This selenide ionic form of Se is catalytic as shown by the inhibition of both catalysis and superoxide generation by iodoacetic acid and mercaptosuccinic acid.
3) Organic selenium catalysts of the configuration RSSe⁻, the selenopersulfide anion, is catalytic in the presence of thiols, and RSSe⁻ continues to generate superoxide (O₂⁻) ion as long as sufficient concentrations of O₂⁻ and thiol are in the medium. All of these selenium compounds derived from selenite or selenium dioxide reacting with glutathione (GSH) are converted to elemental selenium (Se.) as follows; SeO₃(SeO₂)+2GSH→2GSSeSG→2GSSG+Se.. Elemental selenium (Se.) is non-catalytic and not toxic.
4) Compounds of selenium of the configuration RSe⁻ or RSSe⁻ are toxic due to the catalytic acceleration of thiol oxidation which produces O₂⁻, H₂O₂ and the more toxic free radical, the hydroxyl radical (.OH). This chemistry had been discussed by Misra (J. Biol. Chem., 249:2151-2155 (1974)) for the spontaneous oxidation of thiols. The association of rapid thiol catalysis by selenium compounds of the configuration RSe⁻ or RSSe⁻ and the toxicity from which it produced free radicals and reactive toxic oxygen products was recognized in 1992 by one of the inventors.

The use of selenium for the treatment of experimental cancer in animals and cancer in humans in vivo has been extensively described by many authors, such as Milner et al. (“Selenium and transplantable tumors,” (Spallholz, J. E., Martin, J. L., Ganther, H. E., eds.) Selenium in Biology and Medicine, AVI Publishing Co. (1981)); Ip et al. (“Relationship between the chemical form of selenium and anticarcinogenic activity,” CRC Press, Inc., pp. 479-488 (1992)); Caffrey et al. (Cancer Research, 52:4812-4816 (1992)); Schrauzer (Biol. Trace Elem. Res., 33:51-62 (1992)); and Yan et al. (Biochemical Pharmacology, 45:429-437 (1993)). The use of selenium as a cytotoxic agent to both normal cells and cancer cells in vitro for the injection of selenodiglutathione into a tumor mass to kill tumor cells has been described in U.S. Pat. No. 5,104,852, issued to Kralick et al. In U.S. Pat. No. 4,671,958, Rodwell et al. described many antibacterial drugs, 3 antiviral drugs, 1 antifungal drug, 7 antineoplastic drugs, 3 radiopharmaceuticals, 3 heavy metals and 2 antimycoplasmals as drugs for antibody mediated delivery. The pharmacology for all of these drugs which are listed in Table 1 of U.S. Pat. No. 4,671,958 is generally understood. Table 1 of the Rodwell et al. patent does not contain selenium because its pharmacological action as a free radical generator of (O₂⁻) and other reactive oxygen molecules was not understood or known at that time.

Humans and other animals are in a constant immune-system battle with agents of infectious disease, such as bacteria, viruses, pathogenic fungi and protozoa. A particular problem for healthcare professionals dealing with these infectious agents has been the development of antibiotic resistant bacteria, which are refractory to many of the antibiotic agents that initially promised to provide a reliable cure.

A particularly critical problem for the healthcare industry has been the development and spread of infections within the hospital environment. While medical devices such as intravascular catheters provide a method for delivering fluids, medications, and nutrients to patients, their use is also frequently associated with hospital-spread infections. Approximately 50% of hospital patients require intravenous access, and about 1-10% of catheters used eventually become contaminated with bacteria. The consequences of such contamination range from phlebitis (venous inflammation) to sepsis (a systemic toxic condition resulting from the body-wide spread of bacteria and/or their toxic products through the blood from the focus of infection).

Adhesive tapes used in conjunction with catheters and other medical devices are uniquely vulnerable to facilitating the spread of such bacterial infections in hospitals. This is because they are generally not washed or sterilized once they have been unpackaged, and, further, because a single roll of tape is generally used by several clinicians and on many different patients, and thereby becomes exposed to many different individuals. Furthermore, such adhesive tapes are frequently handled using ungloved hands and applied in close contact to the intravascular insertion site for extended periods of time. Indeed, one study found surprisingly high levels of infectious bacteria, including Staphylococcus aureus, on the outer layer of rolls of medical tape (3M TRANSPORE™) that were in use throughout a hospital in Toronto (see Redelmeier and Livesley (1999) J. Gen. Int. Med., 14:373-5).

As a result of widespread public concern with such infectious bacteria, antimicrobial treatment of materials such as fabrics, fibers, polymers and even children's toys have become increasingly popular. While the demand for such antimicrobial articles is high, relatively few types of such articles are available, and not all of those available are both effective against a broad spectrum of bacteria and capable of sustained antimicrobial activity without being released into the environment or being gradually chemically inactivated.

Research and development of durable functional fibers has advanced in recent years, including new methods of incorporating antibiotics as bactericidal agents directly into the fibers. The chemical and medical literature describes many compounds that have antimicrobial activity. Although the mechanism of action of these antimicrobials varies, they generally function by one or more of the following manners: inhibition of cell wall synthesis or repair; alteration of cell wall permeability; inhibition of protein synthesis; and/or inhibition of the synthesis of nucleic acids (DNA or RNA).

At least since the 1870s, silver ions have been recognized as an antibacterial agent, and has been particularly noted for their ability to resist the development of drug-resistance in target bacteria. In general, silver cations (Ag+) are thought to possess antimicrobial activity because they are highly reactive chemical structures that bind strongly to electron donor groups containing sulfur, oxygen, or nitrogen that are present in microbial targets. The biological target molecules generally contain all these components in the form of thio, amino, imidazole, carboxylate, and phosphate groups. Silver ions act by displacing other essential metal ions such as calcium or zinc. The direct binding of silver ions to bacterial DNA may also serve to inhibit a number of important transport processes, such as phosphate and succinate uptake, and can interact with cellular oxidation processes as well as the respiratory chain. The silver ion-induced antibacterial killing rate is directly proportional to silver ion concentrations, typically acting at multiple targets. Indeed, for silver ion-based antimicrobial articles and devices to be effective as antimicrobial vectors, the silver ions with which they are impregnated must be slowly released into the environment so that they are free to contact and inhibit the growth of destructive microbes in the environment. Accordingly, the antimicrobial activity of silver-coated and silver-impregnated articles and devices is dependent upon the controlled release rate of the unbound, free silver ions they carry, and the continued antimicrobial efficacy of such silver-based antimicrobials is necessarily limited by the supply of free silver ions they retain.

The inventor's previous work, as disclosed and claimed in U.S. Pat. Nos. 5,783,454; 5,994,151; 6,033,917; 6,040,197; 6,043,098; 6,043,099; and 6,077,714; all issued to Spallholz et al., discloses methods for making selenium-carrier conjugates by covalently attaching (i) an organic selenium compound selected from the group consisting of RSeH, RSeR′, RSeSeR and RSeSeR′, wherein R and R′ each comprise an aliphatic residue containing at least one reactive group selected from the group consisting of aldehyde (ketone), amino, alcoholic, phosphate, sulfate, halogen, alkane, alkene, alkyne or phenolic reactive groups and combinations thereof, to (ii) a carrier having a constituent capable of forming a covalent bond with said reactive groups of said selenium compound to produce a selenium-carrier conjugate which is capable of specific attachment to a target site. The carrier may be a protein, such as an antibody specific to a bacteria, virus, protozoa, or cell antigen, including without limitation, cell surface antigens, a peptide, carbohydrate, lipid, vitamin, drug, lectin, plasmid, liposome, nucleic acid or a non-metallic implantable device, such as an intraocular implant or a vascular shunt.

The '454 patent demonstrates the cytotoxicity of selenofolate of the configuration Folate-SeR, which produces superoxide in the presence of glutathione or other thiols, as measured by lucigenin chemiluminescence; this modified vitamin compound is cytotoxic to cancer cells upon uptake in a dose dependent manner. The '454 patent also demonstrates the ability of selenocystamine attached to plastic or a cellulose matrix to inhibit cellular growth.

Wound infections, which may occur in burn victims, patients with other traumatic or necrotic lesions (e.g., diabetics) and patients with surgical wounds, are among the most difficult bacterial infections encountered in treating patients. Two of the more common causative agents of wound infections are Staphylococcus aureus and Pseudomonas aeruginosa. The reported mortality rate among patients infected with P. aeruginosa ranges from 36% to over 70% in severely burned patients, while S. aureus mortality ranges from 8% to 33%. Both organisms are opportunistic pathogens, causing few infections in healthy individuals but readily infecting an individual once host defenses are compromised, such as occurs with the removal of skin in burns. S. aureus infection originates from the normal flora of either the patient or healthcare workers, while P. aeruginosa is acquired from the environment surrounding the patient. Both bacteria may enter the wound through a moist gauze bandage or during bandage changes.

Both P. aeruginosa and S. aureus may exist within the wound as biofilms. A biofilm is presently defined as a sessile microbial community characterized by cells that are irreversibly attached either to a substratum or to each other. The biofilm is made up of multiple layers of bacteria, nucleic acids and exopolysaccharides that can attain several hundred microns in thickness. It has been shown that P. aeruginosa biofilms form in distinct developmental stages; reversible attachment, irreversible attachment, maturation and dispersion. Clinically, biofilms present serious medical management problems through their association with different chronic infections. During chronic infections, the biofilm serves as a reservoir of bacteria from which the planktonic cells detach and spread throughout the tissue and/or enter the circulatory system with resulting bacteremia or septicemia. Factors specific to the bacteria may influence the formation of bacterial biofilms at different infection sites or surfaces. For example, during the initial attachment stage the flagellum, lipopolysaccharides (LPS) and possible outer membrane proteins play a major role in bringing P. aeruginosa into proximity with the surface as well as mediating the interaction with the substratum.

Silver or antibiotics attached to or embedded in gauze have been shown to be efficacious in preventing wound infection. Additionally, silver compounds, such as silver nitrate and silver sulfadiazine, leaching from dressings are toxic to human fibroblasts even at low concentrations. Therefore, due to its lack of stability and recent concerns regarding both safety and efficacy, these have additional drawbacks due to leaching or loss of concentration and effectiveness through diffusion. Thus, effective alternative antimicrobial agents that contact the thermally injured/infected tissues and prevent the development of bacterial biofilms are required.

In addition, the selenium-carrier conjugates of the prior art (as taught in the various patents listed above) require covalent attachment of the selenium compound to the carrier molecule in order to be effective. In addition, the leaving groups generated when RSe— is produced, as taught by the prior art, are toxic. Therefore there is a need for sustainable and effective biocidal agents that both avoid the formation of resistant microbes and can be adapted for use in manufacturing materials, and in application to solid substrates, which overcome the disadvantages and defects of the prior art. It is to such improved biocidal compositions, and methods of production and use thereof, that the present invention is directed.

### BRIEF DESCRIPTION OF THE DRAWINGS

FIG. 1 illustrates the ability of the selenium modified bonding agent, AAEMA, to generate superoxide radicals.

FIG. 2 is a schematic diagram for coating cellulose discs with AAEMA or Se-MAP. Se-MAP (22% [wt/wt] Se) was diluted in AAEMA to the desired concentrations and applied to 6-mm cellulose discs. Polymerization was initiated with 3% H₂O₂. Discs, including untreated discs, were cured at 66° C. until dry and then washed twice with PBS (pH 7.4). Discs were dried at 37° C. and sterilized in 70% ethanol. Discs were dried again at 37° C. and stored at room temperature until used in the assays. Immediately prior to use in every assay, 300 μM GSH was added to each disc.

FIG. 3 graphically depicts that Selenium in Se-MAP on cellulose discs generates superoxide in a lucigenin-enhanced CL assay. Untreated, AAEMA-coated, or Se-MAP-coated (with various concentrations of selenium) cellulose discs were placed in a CL assay cocktail containing 1 μg/ml GSH and 1 μg/ml lucigenin in 0.05 M sodium phosphate buffer (pH 7.4), and CL was measured for 5 min. The final concentration of selenium present on the Se-MAP-coated discs is indicated on the graph. Values represent the means of triplicate experiments±standard errors.

FIG. 4 graphically depicts that Selenium in Se-MAP inhibits P. aeruginosa and S. aureus biofilm formation. Untreated, AAEMA-coated, or Se-MAP-coated cellulose discs were prepared as described for FIG. 2 and inoculated with P. aeruginosa (A) or S. aureus (B). Biofilms were allowed to form for 24 h. The discs were gently washed twice in PBS to remove planktonic bacteria. Adherent bacteria (biofilm) were removed from the discs by vortexing in PBS, and CFU were determined by plating 10-fold serial dilutions on LB agar. The final concentrations of selenium present on the Se-MAP-coated discs are indicated on the graphs. Values represent the means of triplicate experiments±standard errors. A one-way analysis of variance with Dunnett's multiple comparisons post test using the AAEMA-coated discs as the control was done to determine statistical significance. *, P<0.05; **, P<0.01.

FIG. 5 illustrates SEM analysis of P. aeruginosa (A to C) and S. aureus (D to F) biofilm formation on untreated, AAEMA-coated, or Se-MAP-coated (0.2% selenium) cellulose discs. Biofilms were allowed to form as described for FIG. 4. After 24 h of incubation at 37° C., the discs were fixed, dried, affixed to aluminum mounts, and sputter coated with platinum and palladium. Observations were performed at 6 to 7 kV with a scanning electron microscope. Five fields of view were examined from randomly chosen areas from the optical surface of each sample at magnification of ×1,500 for untreated and AAEMA-coated discs and at ×5,000 for the 0.2% selenium Se-MAP-coated discs. Each experiment was conducted in triplicate. Representative fields of view are shown. Bars, 20 μm. Crystals visible in panels B and F are artifacts of fixation.

FIG. 6 graphically depicts a comparison of the effectiveness of cellulose discs coated with Se-MAP in inhibiting the development of biofilms formed by the P. aeruginosa strain MPAO1 and its sodM mutant, PA4468ΔsodM. Biofilm development and analysis were conducted as described for FIG. 4. Values represent the means of triplicate experiments±standard errors.

FIG. 7 graphically depicts that Se-MAP coating on cellulose discs remains stable for 1 week in aqueous solution. Cellulose discs were prepared and coated with AAEMA or Se-MAP in AAEMA (FIG. 2) and soaked for 1 week as described in Materials and Methods of Example 5. The discs were then dried and tested for the ability to inhibit biofilm formation by P. aeruginosa (A) and S. aureus (B) as described for FIG. 4. The final concentrations of selenium present on the Se-MAP-coated discs are indicated on the graphs. Values represent the means of triplicate experiments±standard errors. A one-way analysis of variance with Dunnett's multiple comparisons post test using the AAEMA-coated discs as the control was done to determine statistical significance. **, P<0.01.

FIG. 8 graphically depicts the reduction in growth of bacteria in vitro of N—N′-Bis-steroyl selenocystamine impregnated polyurethane plastic versus a control of the same polyurethane.

### DETAILED DESCRIPTION OF THE INVENTION

Before explaining at least one embodiment of the invention in detail by way of exemplary drawings, experimentation, results, and laboratory procedures, it is to be understood that the invention is not limited in its application to the details of construction and the arrangement of the components set forth in the following description or illustrated in the drawings, experimentation and/or results. The invention is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used for recombinant DNA, oligonucleotide synthesis, and tissue culture and transformation (e.g., electroporation, lipofection). Enzymatic reactions and purification techniques are performed according to manufacturer's specifications or as commonly accomplished in the art or as described herein. The foregoing techniques and procedures are generally performed according to conventional methods well known in the art and as described in various general and more specific references that are cited and discussed throughout the present specification. See e.g., Sambrook et al. Molecular Cloning: A Laboratory Manual (2^{nd} ed., Cold Spring Harbor Laboratory Press, Cold Spring Harbor, N.Y. (1989) and Coligan et al. Current Protocols in Immunology (Current Protocols, Wiley Interscience (1994)), which are incorporated herein by reference. The nomenclatures utilized in connection with, and the laboratory procedures and techniques of, analytical chemistry, synthetic organic chemistry, and medicinal and pharmaceutical chemistry described herein are those well known and commonly used in the art. Standard techniques are used for chemical syntheses, chemical analyses, pharmaceutical preparation, formulation, and delivery, and treatment of patients.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims. The invention is based, in part, upon the finding that inorganic and organic selenium compounds, which catalyze the formation of free radical superoxide ions in the presence of oxygen and a reducing agent such as a reduced thiol group or other electron donor, have biocidal activity when brought into contact with a species of interest, such as but not limited to, bacteria, viruses, mold, fungi, protozoa parasites, plant cells, animal cells, biological materials and combinations thereof. While not wishing to be bound by a single theory of their mechanism of biocial action, such selenium-containing compounds appear to provide for catalytic superoxide-mediated damage to a target species of interest by generating short-lived but highly reactive superoxide (O₂—) ions in the presence of oxygen (O₂) and reduced thiol groups (SH— groups) or other electron donating groups (i.e., Cofactors such as but not limited to, NADPH in NADPH dependent reductase) present on the target species of interest itself (e.g., from membrane proteins or other reducing sources present on or near the target species). Accordingly, the invention provides novel selenium-based methods, formulations and articles for the treatment or prevention of infectious, disease-causing agents and other unwanted cells.

The present invention is related to biocidal compositions comprising a selenium composition. Broadly, the biocidal compositions include at least one selenium atom that is capable of forming the species Se— and thus results in free radical generation that is damaging to any species of interest if the Se— is available to a surface of the species of interest in a proximity that allows for free radical catalysis to be performed.

The biocidal composition may further include an acrylate compound, such as but not limited to, a methacrylate compound. In this manner, the selenium compound and the acrylate compound form an organoselenium-acrylate polymer. The acrylate compound forms an insoluble matrix that interdigitates the selenium compound; therefore, the acrylate compound provides a means for permanently attaching, in a non-covalent manner, the selenium compound to a surface of a solid substrate. Examples of particular acrylate compounds that may be utilized in accordance with the present invention include, but are not limited to, 2-(Acetoacetoxy)ethylmethacrylate (AAEMA); butoxyethyl methacrylate (BEM); polymethyl methacrylate (PMMA); butoxyethyl acrylate; polymethyl acrylate; trimethyloipropane triacrylate (TMPTA); and combinations or derivatives thereof.

The selenium composition comprises a selenium compound selected from the group consisting of RSeH, RSeR′, RSeSeR, RSeSeR′, and RseX. R and R′ comprise aliphatic and/or phenolic residues, and R′ must be a group that will readily hydrolyze and/or be labile due to an enzymic reaction (such as but not limited to, an ester). X is a protecting group selected from the group consisting of a halogen, an imide, a cyanide, an azide, a phosphate, a sulfate, a nitrate, a carbonate, selenium dioxide, and combinations thereof.

In one embodiment, the selenium composition comprises the formula R—Se—X. In one embodiment, R includes an aliphatic or phenolic residue or a combination thereof. X is a protecting group that can be any electron withdrawing group known in the art; preferably, X is selected from the group consisting of a halogen, an imide, a cyanide, an azide, a phosphate, a sulfate, a nitrate, a carbonate, selenium dioxide, and combinations thereof. The protecting group can be removed once the selenium composition is produced and/or after the selenium composition is disposed in a solution, suspension, encapsulated molecule or polymer matrix, or covalently attached. The protecting group can be removed in vitro or in vivo, if no toxic group is produced.

In one embodiment, the selenium composition comprises a formula selected from the group consisting of R—Se—CN, R—Se—Cl, R—Se—Br, R—Se—I, R—Se—N₃, R—Se—S—R, and R—Se—O—R.

In another embodiment of the present invention, the effective amount of the selenium compound is in a range of from about 0.01 μg to about 100 μg of elemental selenium per square centimeter of surface area. In another embodiment of the present invention, the biocidal compositions are particularly effective against Pseudomonas aeruginosa and Staphylococcus aureus.

The present invention also includes a composition that comprises the biocidal compositions disclosed herein above, disposed on and attached to a surface of a solid substrate. The selenium compound and the acrylate compound form an organoselenium-acrylate polymer whereby the acrylate compound interdigitates the selenium compound and permanently attaches the selenium compound to the surface of the solid substrate in a non-covalent manner. The biocidal composition thereby prevents formation of bacterial biofilms on the surface of the solid substrate. In this manner, the selenium compound is non-covalently attached to the surface of the solid substrate via the polymer matrix.

The biocidal compositions of the present invention may be utilized in a method for preventing growth of a species of interest (i.e., at least one of a living cell and a living organism) on an object or in a composition. The method includes the steps of applying a matrix, such as but not limited to, an organoselenium-acrylate polymer, as described herein above and comprising an effective amount of any of the selenium compositions described above, to an object or composition (i.e., a solid substrate) or disposing the effective amount of the selenium composition in a solution, suspension, or encapsulated particle, wherein the selenium compound is covalently or non-covalently associated with the object, composition, solution, suspension or encapsulated particle. In such method, the selenium compound is available to a surface of the living cell/organism to allow formation of the selenium anion Se— and free radical species. The selenium anion Se— remains permanently attached to the surface to which it is non-covalently attached via the matrix, while the free radical species inhibits and/or inactivates the living cell/organism, thereby preventing growth of the living cell/organism on said surface. The selenium compound may be attached to the other components of the selenium composition by any non-covalent means known to a person having ordinary skill in the art, or the selenium compound may simply be present in a mixture or solution composition.

The present invention is also related to a method of treating or preventing the development or transmission of a species of interest (i.e., an undesired living cell and/or organism) in or on a subject. In the method, a solid substrate having the organoselenium-acrylate polymer matrix (described in detail herein above) disposed thereon is provided and disposed in or on a subject to prevent the development or transmission of a undesired living cell/organism in or on a subject at the point at which the solid substrate comes into contact with the substrate.

The presently disclosed and claimed invention provides a new bacterialcidal and viralcidal agent. The presently disclosed and claimed invention also provides a methodology to use of the aforementioned free radical technology as bacterialcidal or viralcidal agents. The presently disclosed and claimed invention further provides a method for directing the localized production of superoxide and descendant species thereof for selective destruction or modification of cells, tissue, membranes or extracellular fluids to combat a variety of localized problems, from infections, to cancer, to post surgical clotting and fibrosis.

The present invention also provides a new biocidal agent for addition to one of many different types of plastics during the manufacturing process. Another embodiment of the present invention provides a method for directing the localized production of superoxide and descendant species thereof for selective destruction or modification of cells, tissue, membranes or extracellular fluids to combat a variety of localized problems, from infections and scarring around implantable devices to biofouling within tubing or on other products.

The present invention comprises the organic covalent chemical attachment of organic selenium compounds of the configuration, RSeH, RSeR′, RSeSeR or RSeSeR′ to various hydrocarbons, where R and R′ are each selected from the group consisting of aliphatic residues containing one or more aldehyde (ketone), carboxylic, amino, alcoholic, phosphate, sulfate, halogen, alkane, alkene, alkyne or phenolic reactive groups, and combinations thereof, such as (but not limited to): —(CH₂)ₙHN₂, —(CH₂)ₙCOOH, —(CH₂)ₙ, wherein n is an integer equal to or greater than 1. R and R′ can be the same or different. Selenosulpher, selenonitride, selenosulphernitride, and silicone compounds or polymers may also be used. The present invention is directed to the prevention of a wide spectrum of biotic infections and biofilms or other biofouling associated with the surface of any plastic device.

An interesting discovery of the invention is that the tissue, cell or bodily fluid provides the reducing power for the generation of superoxide (O₂.⁻). However, should additional reducing power be needed in vivo it can be supplied by exogenous glutathione or cysteine according to known techniques.

The attachment of selenium compounds of the configurations described above to tubing, devices, or other plastic material, when presented to either endogenous thiols, such as glutathione which occurs in all aerobic living cells, or exogenous thiols, such as glutathione or cysteine, produces superoxide (O₂.⁻), hydrogen peroxide, the hydroxyl radical (.OH) and other cytotoxic reactive oxygen species so as to collectively form a localized free radical pharmacology based upon the catalytic selenium anion, RSe— Because superoxides are so deadly to cells, the body has natural mechanisms to destroy the superoxides, i.e., with superoxide dismutase. Thus, the superoxide radical, O₂.⁻, has a relatively short half life and will degrade. H₂O₂ and .OH are secondarily produced and are slightly longer lived. As used herein, for brevity, superoxide will include O₂.⁻ and its descendent oxygen species. Because of the short life, O₂.⁻ must be generated at or near the site of intended destruction. The covalent attachment of selenium compounds which produce the RSe— anion provide for a new analytical chemistry based upon the generation and detection of superoxide (O₂.⁻) using chemiluminescence or the reduction of various dyes, such as methylene blue or cytochrome C. Methylene blue and cytochrome C in the oxidized form may be reduced by selenium attached to a receptor molecule, through the generation of superoxide. The amount of reduced methylene blue or cytochrome C can be measured spectrophotometrically and quantitated, thereby reflecting the concentration of the molecule to which selenium is attached.

Therefore, another embodiment of the present invention is related to the preparation of a plastic material having a biocidal composition as disclosed herein incorporated into said plastic material. In one embodiment, said method includes providing a molten plastic and incorporating therein a biocidal composition as disclosed herein above. The molten plastic is then allowed to harden to form a plastic material, wherein the biocidal composition migrates to a surface of the plastic material such that the biocidal composition remains attached to the surface of the plastic material. When the selenium compound comes into contact with a surface of the living cell and/or living organism, the selenium anion Se— and free radical species are generated. The selenium anion Se— remains attached to the surface of the plastic material, while the free radical species inhibits and/or inactivates said living cell and/or living organism, thereby preventing growth of the living cell and/or living organism on the plastic material.

The term “molten plastic” as used herein will be understood to include not only a plastic that has been heated to the point that it is in a completely liquid form, but will also include plastic that has been heated sufficiently so that the plastic is softened (but not liquefied). Therefore, the term “molten plastic” encompasses heated plastics in both liquid as well as softened, semi-solid forms.

Alternatively, a non-heated form of plastic may be used. In another embodiment of said method of preparing a plastic material having a biocidal composition incorporated therein, a liquid monomer is provided, and the biocidal composition as disclosed herein above is mixed therewith. Polymerization is then initiated to form a mixed polymer that includes the biocidal composition. In this manner, the biocidal composition may rise to the surface of the plastic material as the material hardens; alternatively, the biocidal composition may be impregnated throughout said plastic material. When the biocidal composition is incorporated throughout said plastic material, the plastic material can wear; that is, the plastic material may slowly dissolve during use thereof, for example but not limited to, a polymer used as a knee implant); however, as the plastic material wears, selenium will still be continuously found on the surface of the plastic material.

In the same manner as the method described above, when the selenium compound comes into contact with a surface of the living cell and/or living organism, the selenium anion Se— and free radical species are generated. The selenium anion Se— remains attached to the surface of the plastic material, while the free radical species inhibits and/or inactivates said living cell and/or living organism, thereby preventing growth of the living cell and/or living organism on the plastic material.

The present invention is also related to a method of treating or preventing the development or transmission of an undesired living cell and/or organism in or on a subject. In the method, a plastic material having a biocidal composition incorporated therein during a manufacturing process thereof whereby the biocidal composition either (1) migrated to a surface of the plastic material and remains attached thereto, or (2) is disposed throughout the plastic material (both as described in detail herein above), is provided. The biocidal plastic material is then disposed in or on a subject to prevent the development or transmission of the undesired living cell and/or organism in or on a subject at the point at which the solid substrate comes into contact with the substrate.

As utilized in accordance with the present disclosure, the following terms, unless otherwise indicated, shall be understood to have the following meanings:

The terms “covalently attached”, “covalent bonding” and “covalent attachment” as used herein will be understood to refer to a stable chemical link between two atoms produced by sharing of one or more pairs of electrons. Covalent bonding is an intramolecular form of chemical bonding characterized by the sharing of one or more pairs of electrons between two components, producing a mutual attraction that holds the resultant molecule together. Atoms tend to share electrons in such a way that their outer electron shells are filled. Such bonds are always stronger than the intermolecular hydrogen bond and similar in strength to or stronger than the ionic bond. In contrast to the ionic and metallic bond, the covalent bond is directional, i.e., the bond angles have a great impact on the strength of the bond. Because of the directional character of the bond, covalently bound materials are more difficult to deform than metals.

The terms “noncovalently attached”, “noncovalent bonding”, “noncovalent interactions” and “noncovalent attachment” as used in accordance with the present invention will be understood to refer to any methods of attachment that do not involve a molecule-to-molecule covalent attachment. A noncovalent bond is a chemical bond in which, in contrast to a covalent bond, no electrons are shared. Noncovalent bonds are relatively weak, but they can sum together to produce strong, highly specific interactions between molecules.

Noncovalent bonding refers to a variety of interactions that are not covalent in nature between molecules or parts of molecules that provide force to hold the molecules or parts of molecules together, usually in a specific orientation or conformation. Specific examples of non-covalent interactions include, but are not limited to, ionic bonds, hydrophobic interactions, hydrogen bonds, Van der Waals forces (aka London dispersion forces), Dipole-dipole bonds, and the like. “Noncovalent bonding”, “Noncovalent interactions” and “Noncovalent forces” all refer to these forces as a whole without specifying or distinguishing which specific forces are involved because noncovalent interactions often involve several of these forces working in concert. Noncovalent bonds are weak by nature and must therefore work together to have a significant effect. In addition, the combined bond strength is greater than the sum of the individual bonds. This is because the free energy of multiple bonds between two molecules is greater than the sum of the enthalpies of each bond due to entropic effects.

The term “biocide” as utilized herein refers to a chemical substance capable of killing different forms of living organisms. A biocide can be a pesticide, such as but not limited to, fungicides, herbicides, insecticides, algicides, moluscicides, miticides, and rodenticides; or the biocide can be an antimicrobial, such as but not limited to, germicides, antibiotics, antibacterials, antivirals, antifungals, antiprotozoans, and antiparasites.

The term “plastics” as utilized in accordance with the present invention refers to any of numerous substances that can be shaped and molded when subjected to heat or pressure. Plastics are easily shaped because they consist of long-chain molecules known as polymers, which do not break apart when flexed. Plastics are usually artificial resins but can also be natural substances, as in certain cellular derivatives and shellac. Plastics can be pressed into thin layers, formed into objects, or drawn into fibers for use in textiles. Most do not conduct electricity well, are low in density, and are often very tough. Examples of plastics that may be utilized in accordance with the present invention include, but are not limited to, polyvinyl chloride, methyl methacrylate, polystyrene, polyurethane, and the like. The term “plastics” as used herein will also be understood to include waxes.

The term “species of interest” as utilized in accordance with the present invention refers to any living cell, virus or organism that is killed or suppressed when exposed to free radicals. The term “species of interest” includes, but is not limited to, prokaryotes such as bacteria and archebacteria; viruses; eukaryotes such as mold, fungi, protozoans, parasites, plant cells and animal cells; and biological materials such as proteins, carbohydrates, lipids and nucleotides. Examples of prokaryotes include, but are not limited to, bacteria such as for example, Staphylococcus strains such as but not limited to, S. aureus; Pseudomonas strains such as but not limited to, P. aeruginosa; Escherichia strains such as but not limited to, E. coli; and Bacillus strains such as but not limited to, B. subtilis. Examples of viruses include, but are not limited to, Poxvirus, Papillomavirus, Filovirus, Bornavirus, Mimivirus, Picornavirus, Adenovirus, Retrovirus, Paramyxovirus, Flavivirus, Parvovirus, Hepadnavirus, Calcivirus, and Orthomyxovirus and Bacteriophage; specific viral examples include HIV, Rhinovirus, West Nile, Influenza, smallpox, and herpes simplex. Examples of parasites include, but are not limited to, arthropod parasites, helminth parasites, protozoal parasites, and hematoprotozoal parasites; specific examples include demodex mange, hookworm, and coccidia. Examples of eukaryotic cells include, but are not limited to, fibroblast cells, barnacles, epithelial cells, and cancer cells, including but not limited to, prostate cancer cells, breast cancer cells, leukemia, and lymphoma.

The terms “nucleotide” and “nucleic acid segment” as used herein shall mean a nucleotide of genomic, cDNA, or synthetic origin or some combination thereof, and thus includes naturally occurring nucleotides and modified nucleotides. The term “protein” referred to herein means a protein of cDNA, recombinant RNA, or synthetic origin or some combination thereof. The term “polypeptide” as used herein is a generic term to refer to native protein, fragments, or analogs of a polypeptide sequence. Hence, native protein, fragments, and analogs are species of the polypeptide genus.

“Treatment” refers to both therapeutic treatment and prophylactic or preventative measures. Those in need of treatment include those already with the disorder as well as those in which the disorder is to be prevented.

A “disorder” is any condition that would benefit from treatment with the compositions of the present invention. This includes chronic and acute disorders or diseases including those pathological conditions which predispose the mammal to the disorder in question.

The terms “cancer” and “cancerous” refer to or describe the physiological condition in mammals that is typically characterized by unregulated cell growth. Examples of cancer include but are not limited to, carcinoma, lymphoma, blastoma, sarcoma, and leukemia. More particular examples of such cancers include squamous cell cancer, small-cell lung cancer, non-small cell lung cancer, gastrointestinal cancer, pancreatic cancer, glioblastoma, cervical cancer, ovarian cancer, liver cancer, bladder cancer, hepatoma, breast cancer, colon cancer, colorectal cancer, endometrial carcinoma, salivary gland carcinoma, kidney cancer, renal cancer, prostate cancer, vulval cancer, thyroid cancer, hepatic carcinoma and various types of head and neck cancer.

“Mammal” for purposes of treatment refers to any animal classified as a mammal, including human, domestic and farm animals, nonhuman primates, and zoo, sports, or pet animals, such as dogs, horses, cats, cows, etc.

The non-metal element selenium exists in several catalytic and non-catalytic oxidation states, in vitro and in vivo. If present in sufficient concentrations of thiol compounds, selenium compounds such as selenides, RSe—, oxidize thiols, producing superoxide (O₂⁻) and other biologically reactive oxygen species. Superoxide and the other produced reactive products, hydrogen peroxide, thiol radicals and other organic free radicals are toxic to biological membranes, molecules and cells. When present in sufficient concentration as the selenoselenide anion, RSe⁻, selenium can arrest and kill normal cells, cancer cells, bacterial cells, yeast cells and viruses. When organic selenium compounds are covalently attached to any targeting molecule such as a mono- or polyclonal antibody, peptide or polypeptide, hormone, vitamin, drug, or device, such conjugates comprise a new class of pharmaceuticals and devices that produce free radicals. Selenium is uniquely different from other elements that produce free radicals, i.e., iron, copper or cobalt, in that selenium can readily form small adducts replacing sulfur and it covalently combines with carbon and hydrogen compounds. Such selenium labeled adducts of the proper chemistry will remain non-toxic until activated by a thiol and the free radical pharmacology can be molecularly localized by the carrier molecule. This free radical chemistry is also useful for competitive protein binding assays. The free radical chemistry generated by selenium compounds can be detected by chemiluminescence or reduction of dyes, such as but not limited to methylene blue, by a spectrophotometer providing for quantitation of a compound which binds the antibody, hapten or drug to which selenium is attached and to which it subsequently reacts with thiols.

The present invention is related to selenium compositions of the configuration RSeH, RSeR′, RSeSeR, RseSeR′, and, RSeX, for use as biocidal agents. Each of R and R′ comprise an aliphatic residue containing at least one reactive group selected from the group consisting of aldehyde (ketone), amino, alcoholic, phosphate, sulfate, halogen, or phenolic reactive groups and combinations thereof. X is a protecting group that can be any electron withdrawing group known in the art; preferably, X is selected from the group consisting of a halogen, an imide, a cyanide, an azide, a phosphate, a sulfate, a nitrate, a carbonate, selenium dioxide, and combinations thereof. Specific examples include, but are not limited to, R—Se—Cl, R—Se—Br, R—Se—I, R—Se—CN, R—Se—N₃, R—Se—O—R″, R—Se—S—R″, R—Se—PO₃—R″, R—Se—SO₃—R″, and the like, wherein R″ is H or an aliphatic residue. The protecting group can be removed once the selenium composition is produced and/or after the selenium composition is disposed in a solution, suspension or encapsulated molecule, or covalently attached. The protecting group can be removed in vitro or in vivo, if no toxic group is produced.

The biocidal compositions of the present invention are applied to a target site or target molecule, or surgically implanted at a target site, whereupon superoxide (O₂⁻) is generated when the Se-carrier conjugate reacts with endogenous thiols on the surface of the targeted local tissue, bacteria, virus, protozoa or other targeted compounds. The selenium toxicity produced by the RSe— composition is very localized because it requires that a surface of a species of interest be available for interaction with the RSe— anion. R and R′ are each selected from the group consisting of aliphatic residues containing one or more aldehyde (ketone), carboxylic, amino, alcoholic, phosphate, sulfate, halogen or phenolic reactive groups, and combinations thereof, such as —(CH₂)ₙHN₂, —(CH₂)ₙ COOH, —(CH₂)ₙ-Ø, wherein n is an integer greater than 1, and preferably between about 1 and 50, and more preferably between about 3 to 5. R and R′ are different groups. The R groups themselves have no real role in the method of the invention, other than to provide reactive groups to bind to a surface/plastic and to protect the selenium until it reaches the target sites. Accordingly, the length of the aliphatic chain is not important. The preferred molecular weight of the compound is about 1000 or less, but higher MWs will be suitable. Representative examples of selenium compounds include, but are not limited to NH₂CH₂CH₂SeCH₃ (RSeR′), NH₂CH₂CH₂SeC═OCH₃ (RSeR′), NH₂CH₂CH₂SeSeCH₂CH₂NH— cellulose (RSeSeR′), and NH₂CH₂CH₂SeCN(RSeX). These selenium compounds, when brought into contact with thiol and oxygen, can generate superoxide (O₂⁻), H₂O₂ or hydroxyl radical (.OH) or any other reactive oxygen species. The thiols can be exogenous thiols added for example, to a competitive immunoassay, endogenous thiols found in membranes, cellular cytoplasm or extracellular fluids. If native thiols are insufficient, exogenously supplied glutathione, glutathione derivatives, cysteine or other thiol or other electron donating molecules or atoms can be used expressly for the generation of superoxide. The selenium compositions of the present invention can be used to treat, in a pharmacological manner, cancer, both primary and metastatic; infections and diseases caused by (i) all viruses of all plant, animal or human origin; (ii) all bacteria of all plant, animal or human origin; (iii) all protozoans of all plant, animal or human origin; and (iv) other pathogens. The selenium compositions of the present invention, for example, when available at the surface of the virus, bacteria, protozoa or cancer cells, will catalyze the production of superoxide, H₂O₂ and other reactive oxygen species. Viruses have surface proteins to which the selenium compositions of the present invention may bind or come into close proximity. The selenium reacts with thiols in those surface proteins to generate the superoxide on the surface of the virus. The lack of an uptake mechanism in the virus is not important because the damage is done at the viral or cell surface.

The selenium compounds of the present invention may be non-covalently attached to any solid or stationary matrix such as a cellulose pad, protein pad, other carbohydrate pad, plastic or other polymer matrix, such as but not limited to, rayon, nylon or polyester; or a biocompatable matrix for the purpose of generating superoxide (O₂⁻) and its descendent reactive oxygen species when available to a surface of a species of interest. The device need not be metallic, but may be an organometallic compound or a metal coated with an organo compound to which the selenium compound can attach. The selenium non-covalently attached to the insoluble matrix inhibits cell growth in the localized area of the matrix due to the localized generation of superoxide.

In one aspect, the invention provides a method of treating or preventing growth of a species of interest through contact of a subject with a biocidal composition as described in detail herein, wherein the selenium composition comprises an inorganic or organic selenium compound, or formulation thereof, capable of generating superoxide radicals in the presence of a species of interest. The superoxide radicals generated by the inorganic or organic selenium compound inhibit or inactivate an agent of the species of interest and thereby treat or prevent growth of the species of interest in or on the subject.

In another aspect, the invention provides a method of treating or preventing the development or transmission of a species of interest in or on a subject through the use of a biocidal composition comprising a selenium composition as described in detail herein, wherein the selenium composition comprises an organic selenium compound, or formulation thereof, capable of generating superoxide radicals in the presence of a species of interest. The method involves providing the biocidal composition capable of generating superoxide radicals in the presence of an infectious agent, and applying an effective amount of the biocidal composition to the subject. The superoxide radicals generated by the organic selenium compound inhibit or inactivate the species of interest and thereby treat or prevent the growth or transmission of the species of interest in the subject.

In a further aspect, the invention provides biocidal compositions having, on at least one surface thereof, an effective amount of an inorganic or organic selenium compound, or formulation thereof, capable of generating superoxide radicals in the presence of a species of interest or reduced thiol compound or other electron donating group. The organic selenium compound may be covalently or non-covalently associated with the composition, and an effective amount of the organic selenium compound, or formulation thereof, is retained on or available to a surface of the composition when the composition is in contact with a subject.

In particularly useful embodiments of the biocidal compositions of the invention, the effective amount of the organic selenium compound, or formulation thereof, that is retained on or available to a surface of the composition when such composition is in contact with the subject is sufficient to inhibit or inactivate an agent of infectious disease or other undesired cell(s).

In other embodiments, the organic selenium compound, or formulation thereof, does not comprise a thiol group or a thiol-containing compound. In particular embodiments, the organic selenium compound, or formulation thereof, does not comprise glutathione.

In further embodiments, the subject is a mammal. In particular embodiments, the subject is a human.

In further particular embodiments, the organic selenium compound, or formulation thereof, is non-covalently associated with the biocidal composition. In other embodiments, the organic selenium compound, or formulation thereof, is covalently associated with the biocidal composition.

In particularly useful embodiments, at least about half of the elemental selenium from the organic selenium compound, or formulation thereof, exists in an active state that is capable of generating superoxide radicals in the biocidal composition. In further particular embodiments, the biocidal composition has between about 0.01 μg and about 100 μg of elemental selenium per square centimeter of surface area. In further useful embodiments, the biocidal composition has between about 1 μg and about 10 μg of elemental selenium per square centimeter of surface area. In yet further particular embodiments, the biocidal composition has between about 5 μg and about 6 μg of elemental selenium per square centimeter of surface area.

In general, the invention provides organic selenium compounds, formulations thereof, and associated selenium-carrying biocidal compositions and methods for use thereof in treating or preventing an agent of infectious disease such as a bacteria, a virus, a fungus, or a protozoa, or treating or preventing growth of undesired cells. The details of the proposed chemical mechanism of superoxide formation by selenium, and selenium's proposed involvement in toxicity and carcinostatic activity in vivo, has been reviewed by Spallholz ((1994) Free Radical Biology & Medicine 17: 45-64), the contents of which is incorporated by reference herein in its entirety.

Examples of applications of the biocidal compositions of the present invention are in particular, but not limited to, surface coatings, protective paints, and other coatings in the following: roofing, basements, walls, facades, greenhouses, sun protection, garden fencing, wood protection, tent roof material, fabrics; sanitary: public conveniences, bathrooms, shower curtains, toilet items, swimming pools, saunas, jointing, sealing compounds; requisites for daily life, machines, kitchen, kitchen items, sponge pads, recreational products for children, packaging for food or drink, milk processing, drinking water systems, cosmetics; machine parts: air conditioning systems, ion exchangers, process water, solar-powered units, heat exchangers, bioreactors, membranes; medical technology: contact lenses, bandages, diapers, membranes, implants; consumer articles: automobile seats, clothing (socks, sports clothing, and the like), hospital equipment, door handles, telephone handsets, public conveyances, animal cages, cash registers, carpeting, wallpapers; boat hulls, docks, buoys, drilling platforms, ballast water tanks construction; and the like.

The present invention also provides for the use of the biocidal compositions of the present invention in producing hygiene products or items for medical technology. Examples of hygiene products of this type include, but are not limited to, toothbrushes, toilet seats, combs, bandages, medical devices, plastics, waxes, sanitary items, packaging materials, as well as any article which can come into contact with many people, for example but not by way of limitation, telephone handsets, stair rails, door handles, window catches, and also grab straps and grab handles in public conveyances. Examples of items for medical technology include, but are not limited to, bandages, catheters, tubing, protective or backing films, surgical instruments, and the like.

### EXAMPLES

The following examples serve to illustrate certain useful embodiments and aspects of the present invention and are not to be construed as limiting the scope thereof. Alternative materials and methods can be utilized to obtain similar results.

### Example 1

### Selenium Content and Superoxide Activity Analysis for Bandage Coating

To 150 g of a standard sample of a non-latex cohesive formulation (Andover Coated Products, Inc., Salisbury, Mass.), 0.9 g of the organoselenium-methacrylate compound (selenocyantoacetoxy) butoxyethyl methacrylate (SCABEM) was added drop-wise with mixing, resulting in a cohesive solution having 0.00126 gram Se/gram soln. (0.9 g/150 g non-latex cohesive=0.006 g SCABEM/g ctg; Se is 21% by weight of SCABEM=0.006 g×0.21=0.00126 gram Se/gram soln.). A portion (3.43 g) of this sample was drawn onto a composite cohesive elastic bandage (Andover Coated, Inc., Salisbury, Mass.), air dried for 5 min and then flash dried for 2 min at 100° C. From this composite drawdown, a 10 cm by 30 cm section was cut and then further cut into 1 cm squares for testing. In theory, 3.43 g of this SCABEM-containing solution distributed evenly across the 300 cm² sample should result in 0.0000144 g Se/cm² (i.e., 1.44×10⁻⁵ g Se/cm²=3.43 g soln./300 cm²=0.011 g soln./cm² (i.e., 0.011 g soln. Se/1 cm² sample) and 0.011 g soln/cm²×0.00126 g Se/g soln.=0.0000144 g Se/cm²). The resulting squares were tested, using the standard methodology described above, in both fluorescence and chemiluminescence assays. The fluorescence assay provides a measure of the total selenium deposited on the test square, while the chemiluminescence assay provides a measure of the total reactive selenium available to provide for thiol-dependent catalytic superoxide formation. The results are shown in Table I.

TABLE I
Selenium Activity and Content Analysis for Bandage Coating

| | | Chemiluminescence assay | | Fluorescence assay | | | | |
|---|---|---|---|---|---|---|---|---|
| | Weight | Counts after | Counts/ | reading after | Se content (μg) | dilution | total Se | Se content (μg)/ |
| Sample # | (mg) | 5 minutes | weight | dilution | after dilution | folds | (μg) | weight (mg) |
| 1 | 40 | 567 | 14.18 | 12.5 | 6.93 | 8 | 55.4 | 1.39 |
| 3 | 33 | 989 | 29.97 | 15.1 | 8.65 | 8 | 69.2 | 2.09 |
| 4 | 37 | 922 | 24.92 | 14.4 | 8.19 | 8 | 65.52 | 1.77 |
| 5 | 46 | 605 | 13.15 | 17 | 9.9 | 8 | 79.2 | 1.72 |
| 6 | 44 | 005 | 22.84 | 15.8 | 9.11 | 8 | 72.9 | 1.66 |
| 7 | 45 | 782 | 17.38 | 10.4 | 5.6 | 8 | 44.8 | 0.99 |
| 8 | 44 | 825 | 18.75 | 16.9 | 9.84 | 8 | 78.7 | 1.79 |
| 9 | 40 | 819 | 20.48 | 12.1 | 6.67 | 8 | 53.36 | 1.33 |
| 10 | 42 | 869 | 20.69 | 14.3 | 8.12 | 8 | 64.96 | 1.55 |

Note:
The chemiluminescence assay is to test superoxide generating selenium activity, while the fluorescence assay is to acquire total selenium content. All of these samples were cut off as 1 square centimeter from the bandage.

The total amount of Se in the 12 random samples was 2117.24 μg from the fluorescence data shown in Table I (column labeled “Total Se (μg)”). This was divided by 12 samples=176.44 μg Se/sample, and since each sample holds approximately 11 mg of the SCABEM solution coating, this is equal to 16.04 μg Se/mg SCABEM solution coating.

The total amount of chemiluminescence (counts) afforded by the 12 random samples highlighted in the column labeled “Counts after 5 minutes” above is 12,323 (counts). This was divided by 12 samples, each hosting approximately 11 mg of coating to give 93.4 counts/mg coating. This test had been standardized such that 10 counts are the equivalent of 1 μg of Se, so the equivalent of 9.34 μg of Se/mg coating has been detected. Since the Non-Latex cohesive elastic white formulation contains a measure of optical brightener, and an average of 20 counts was detected from the chemiluminescent analysis of the blank, the actual amount of luminescence detected resulting from superoxide formation is the equivalent of 9.34 μg O₂⁻-2 μg O₂⁻=7.34 μg O₂⁻. These data have shown that 7.34 μg O₂⁻/mg coating of the total 16.0 μg Se/cm² detected in the sample is responsible for the formation of the superoxide. 16.0 μg Se Total×100%=45.76% of Selenium is present in a reactive form capable of generating superoxide in the presence of thiol compound.

This means that the mixing of a specifically chosen organoselenium compound affords ˜46% of the antimicrobial compound at the bandage/skin interface where it produces superoxide in sufficient quantity to kill bacteria and/or other microbes.

The ability of bacteria to migrate from an untreated bottom tape to a top tape when the tapes are stacked one on top of the other and allowed to set on a bacterial lawn for 24 hours was also tested.

TABLE II
Bacterial Migration on Stacked Tapes

| Untreated | Treated |
|---|---|
| 13,334 | 10,100,000 |

Table II demonstrates the difference in bacterial colonies of Pseudomonas aeruginosa between those found on the bottom tape minus those found on the top tape. Thus, a larger number indicates that the top tape is resisting the migration of the bacteria. In the untreated experiment, neither tape contained a selenium coating, while in the treated experiment, only the top tape contained a selenium coating. Each number in Table II is the average of three experiments.

Thus, the results in Table II demonstrate that a selenium coating markedly inhibits the ability of bacteria to migrate onto a selenium coated tape.

### Example 2

### Selenium Attachment to Intraocular Lenses (IOLs)

The ability to non-covalently attach a selenium compound of the present invention to a plastic was demonstrated using an intraocular lens (IOLs). An intraocular lens (or IOL) is an implanted lens in the eye, usually replacing the existing crystalline lens because it has been clouded over by a cataract, or as an alternative to refractive surgery when this procedure is contraindicated. IOLs are typically formed of a plastic such as but not limited to, acrylic, silicone or polymethyl methacrylate (PMMA).

In this Example, 6 mg/ml of diphenyl diselenide (DPDS) was added to the IOL, and the mixture was heated at 50-52.5° C. for 30 minutes. The treated IOLs were then removed from the solution and allowed to dry. Table III demonstrates that this procedure resulted in a lens that produced chemiluminescence with no significant leaching of the selenium compound, and therefore temperature and mixing achieved selenium labeling by hydrophobic inclusion.

This demonstrated that the solution without DTT (the unreduced solution) caused more uptake of the non-covalent DPDS, and that none of the non-covalently attached DPDS was leaching out.

TABLE III

| Final Concentration | | DTT | Chemiluminescence |
|---|---|---|---|
| DPDS | | Present?* | (counts/10 sec)** |
| 6 | mg/ml | Yes | 28 |
| 3 | mg/ml | Yes | 33 |
| 1.5 | mg/ml | Yes | 26 |
| 6 | mg/ml | No | 48 |
| 3 | mg/ml | No | 37 |
| 1.5 | g/ml | No | 92 |

*Presence of DTT reduced
**Background level of chemiluminescence was 20 counts/10 sec.

In addition, oxygen treatment of the IOLs using a plasma treatment allowed selenium attachment to an IOL plastic using a protected selenium compound. The silicone IOL was placed in a plasma chamber and then treated with plasma in the presence of Oxygen gas. The lens was then placed in a buffer solution at pH 5.8 with EDC (1-ethyl-3[3-dimethylaminopropyl]carbodiimide) and sulfo-NHS (N-hydroxysulfosuccinimide), and the carboxyl residues created on the surface of the lens couple with the succinimide group. This activated lens was then reacted with Selenocyanatopropyl amine.

The experimental design for this procedure was as follows:

The IOL was activated by washing in analytical-grade water, placing in a well of a tissue culture plate, and adding 1 ml of a solution prepared by dissolving 540 mg sulfo-NHS and 480 mg EDC in 100 ml 0.25M, pH 6.0 MES buffer. The plate was placed on a shaker and allowed to shake constantly for 2 hours, and then each IOL was washed with analytical-grade water 3 times.

A selenocystamine solution was prepared by dissolving 400 mg selenocystamine.2HCL in 40 ml water and 40 ml ethanol, and a solution of 210 mg NaHCO₃ in 20 ml water was then added into the above solution.

Coupling of Selenium compound to the IOL was performed by transferring 1 ml of the above selenocystamine solution into the tissue culture plate wells. The plates were kept in the dark by use of aluminum foil, and allowed to constantly shake overnight (12 hours minimum). The solution was then removed and the lenses treated with 2 ml of 0.15 mM glutathione (4.6 mg/100 ml normal saline) for one hour. The IOLs were then washed two times with ethanol and two times with water. The IOLs were then put into bottles containing 2 ml of normal saline and autoclaved.

The chemiluminescence results for this experiment are shown in Table IV.

TABLE IV
Chemiluminescence Results of Plasma Treatment
of IOL with Protected Selenium Compound

| | Counts | Background |
|---|---|---|
| Oxygen-Cathode | 468 | 35 |
| Oxygen-Anode | 122 | 15 |

### Example 3

### Non-Covalent Attachment of Selenium to Hydrogel Lenses

Contact lenses are worn by approximately 90 million people worldwide. Early contact lenses were required to be taken out of the eye daily for removal of accumulated protein and lipids discharged by the eye and for sterilization. In addition, poor oxygenation of the cornea, caused by the relatively low oxygen transmissibility of early conventional hydrogel lenses, also limited wearing time. Whereas the great majority of contact lens wearers still remove their lenses daily, the recent arrival of silicone hydrogel lenses, which provide greater oxygen transfer to the cornea, allow the longer term 30-day wear that is now permitted by the FDA. However, despite the improved corneal physiology provided by the new highly oxygen permeable 30-day lenses, bacteria that cause acute red eye or even corneal ulceration are still a clinical concern.

When a contact lens is placed on the eye, the surface of the contact lens is colonized by bacteria more than 50% of the time. The role that this colonization plays in the success of contact lens wear has been a topic of interest for decades. Studies that look at this issue generally fall into 2 categories: studies that have an interest in the characteristics of the bacterial colonization in asymptomatic patients and studies that looked at bacterial colonization in patients with acute red eye or infection. A number of earlier studies used culturing techniques or scanning electron microscopy (SEM) to look at bacteria that are loosely and/or tightly bound to contact lenses taken from asymptomatic patients. There seems to be general agreement across studies to date that the make up and density of bacterial colonization do not change with changes in the contact lens material. How the number of bacteria varies over time and wearing schedule remains less clear. Inflammatory reactions or infections have been reported to be associated with bacterial colonization of the soft contact lens surface, particularly when the lenses are worn for extended time periods. Whereas microbial keratitis does not seem to be exclusively associated with bacteria of a particular gram stain, gram-negative bacteria seem to be associated with contact lens-induced acute red eye, and gram-positive bacteria are associated with contact lens induced peripheral ulcers. Baleriola-Lucas et al. (1991) found a clear association between acute red eye responses in extended wear and gram-negative bacterial contamination, with Serratia marcescens and S. liquefaciens dominating. They felt that their results suggest that there may be an association between bacterial colonization of hydrogel contact lenses and acute adverse responses.

Given the direct and indirect evidence that bacterial colonization of contact lenses is closely associated with acute red eye and corneal infections, a material or coating that inhibits bacterial colonization should substantially improve the safety of contact lens wear. One candidate to serve this role is a non-covalent coating of selenium (Se).

Therefore, a selenium composition may be incorporated into a hydrogel lens in the same manner as that described in Example 2 for the non-covalent attachment of selenium to intraocular lenses. Said selenium coating will prevent bacterial colonization of the contact lens.

### Example 4

### Hydrophobic Inclusion of the Selenium Compounds into Silicon and Acrylics

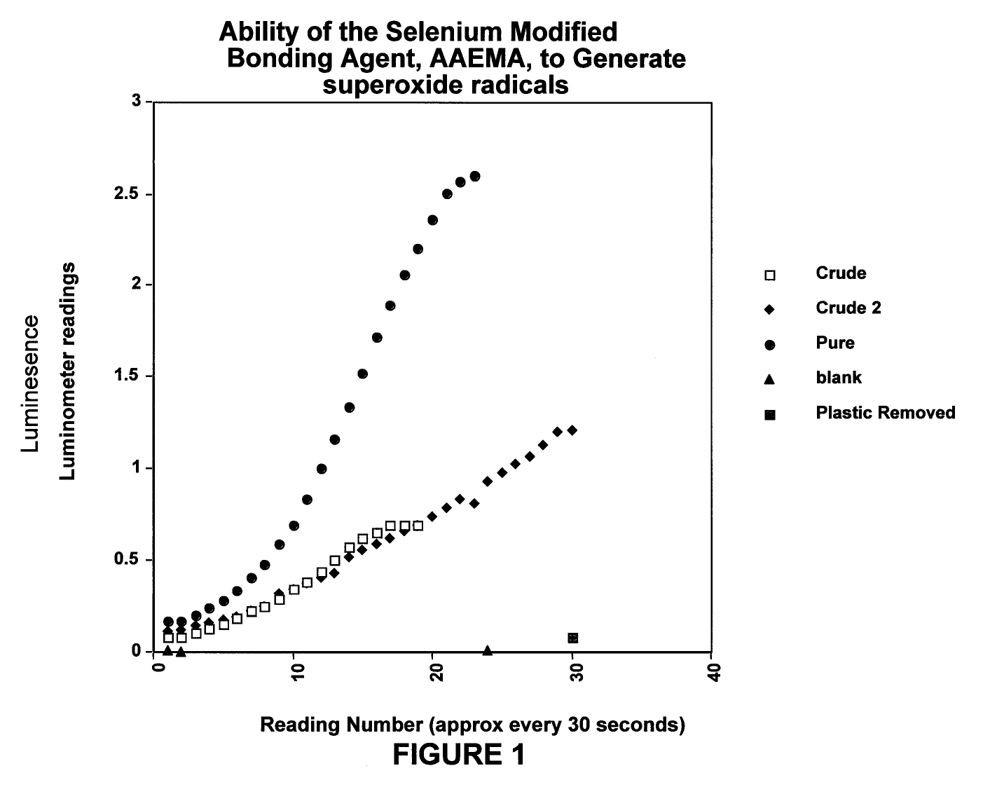

In addition to the hydrophobic inclusion experiments described above, hydrophobic inclusion of a protected selenium compound into a bonding agent was also demonstrated. In this hydrophobic mixing experiment, a organoselenium-methacrylate compound comprising a CN protecting group [2-(selenocyanatoacetoxy)butoxyethyl methacrylate] was mixed with the bonding agent 2-(Acetoacetoxy)ethylmethacrylate (AAEMA) to a final selenium concentration of 5%. The selenium composition was then applied to a surface, such as a PMMA plastic or a human toenail (results with both surfaces were the same), preferably at a concentration of about 100 mg/cm². The ability of the selenium modified bonding agent to generate superoxide radicals was then measured by chemiluminescence, as shown in FIG. 1. In FIG. 1, “Crude 1” and “Crude 2” refer to a mixture of the selenium labeled material with AAEMA; “pure” refers to the pure selenium labeled compound (no AAEMA); “blank” refers to the AAEMA with no selenium; for “plastic removed”, the mixture-coated plastic was soaked in water, and then after removal of the plastic, the aqueous solution was tested for any selenium that may have come off. This experiment demonstrates that the protected selenium compound can be mixed with a bonding agent and coated onto a surface and allowed to dry and still demonstrate chemiluminescence with no significant leaching. The fact that there was very little if any counts present in the “plastic removed” sample indicates that the selenium compound remained associated with the AAEMA treated plastic.

### Example 5

### Se-MAP Non-Covalent Attachment to Cellulose

In this Example, the ability of newly synthesized organo-selenium-methacrylate polymer (Se-MAP) to block biofilm formation by both S. aureus and P. aeruginosa was examined. These bacteria were chosen as they cause a major share of wound infections, and because drug-resistant forms of these bacteria have become a serious problem in the treatment management of these wound infections. The results of this Example show that Se-MAP covalently attached to cellulose discs inhibited P. aeruginosa and S. aureus biofilm formation at a concentration of 0.2% Se in the polymer (w/w). This could lead to the development of a selenium-based antimicrobial coating for cotton materials that will prevent the bacterial attachment and colonization that can ultimately lead to bacterial biofilm formation during chronic infections.

### Methods and Materials for Example 5

Bacterial strains, media and reagents. A S. aureus clinical isolate was obtained from the Clinical Laboratory, University Medical Center, Lubbock, Tex. The prototrophic P. aeruginosa strain PAO1, originally isolated from an infected wound, was obtained from S. E. H. West (Universtiy of Wisconsin, Madison). Bacteria were maintained frozen at −80° C. in Luria Bertani (LB) broth containing 20% glycerol (v/v). Before each assay, a sample of the frozen stock was subcultured in 20 ml LB broth or on LB agar overnight at 37° C. to confirm purity and viability. S. aureus and the P. aeruginosa strains were routinely grown with shaking (225 rpm).

Coating cellulose discs with polymerized Se-MAP. The Se-MAP monomer (22% selenium, w/w) stock solution was dissolved and diluted in 99.99% acetoacetoxyethyl methacrylate (AAEMA) to yield different concentrations of selenium—0.01%, 0.025%, 0.05%, 0.10%, and 0.20% (w/w).

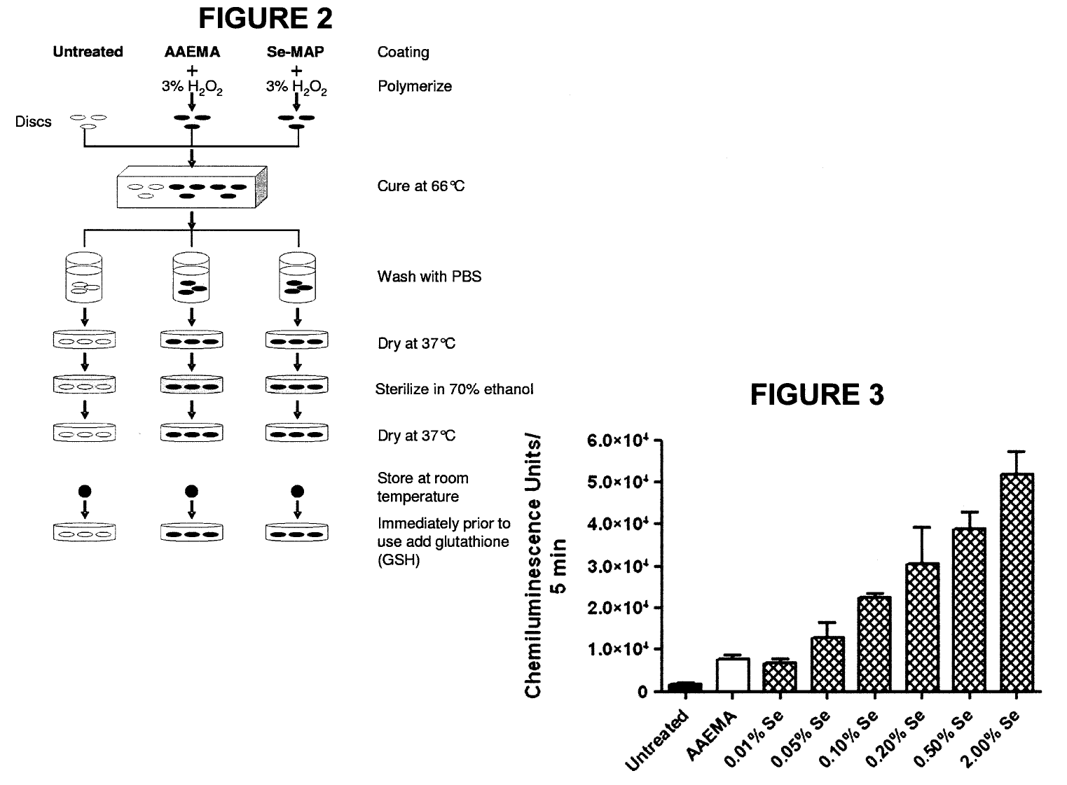

Blank cellulose discs (Becton, Dickinson and Company, Franklin Lakes, N.J.) were washed once and soaked in distilled water overnight. The washed cellulose discs were then dried and coated with AAEMA or Se-MAP as shown in FIG. 2. Briefly, 15 μl of AAEMA or various concentrations of Se-MAP in AAEMA-were added onto each disc. Three μl of 3% H₂O₂ were added to each disc to initiate free radical polymerization. This has little or no effect on the cellulose material. As a result of the in situ polymerization, the polymer is held in place by a combination of van der Waals forces and physical interlinking with the cellulose material. The discs were then transferred to a 66° C. drying oven. After curing, the discs were washed twice (30 min each) in phosphate buffered saline (PBS, pH 7.4) in a water bath at 37° C. The discs were then dried, sterilized with 70% ethanol, dried again, and stored at room temperature until use in the assays. Immediately prior to use in any assay, 15 μl of 300 μM glutathione (GSH) were added to each disc.

Chemiluminescence (CL) assay. In the presence of GSH and oxygen, Se-MAP is reduced to yield RSe⁻ anions and superoxide radicals. A lucigenin-enhanced CL assay was employed to detect the presence of superoxide radicals in solution. Untreated, AAEMA-coated or Se-MAP-coated discs were added to 500 μl aliquots of CL assay cocktail (0.05 M sodium phosphate buffer [pH 7.4] with 1 μg/ml lucigenin and 1 μg/ml GSH). The generation of CL was recorded over a 5-min period in a luminometer (Turner Biosystems; Sunnyvale, Calif.).

Colony biofilm assay. The ability of P. aeruginosa and S. aureus to form biofilms on cellulose discs were quantified as follows. P. aeruginosa and S. aureus were grown overnight in LB broth at 37° C. with shaking. Overnight cultures were washed once with PBS (pH 7.4). Aliquots of fresh LB broth were inoculated with the washed cultures to an optical density (OD₆₀₀) of 0.02 at 600 nm and then regrown at 37° C. with shaking for 4 h to OD₆₀₀ 0.8-0.9. The regrown cultures were washed once with PBS (pH 7.4) and serially diluted in 10-fold steps to obtain a 1×10⁻⁵ dilution. Five-μl aliquots from the 10⁻⁵ dilution were added to previously prepared uncoated cellulose discs, AAEMA-coated discs, and discs coated with Se-MAP at various concentrations of selenium as described above. The inoculated cellulose discs were placed on LB agar plates, and the plates were inverted and incubated at 37° C. for 24 h.

Following incubation, each cellulose disc was gently washed twice with sterile PBS to remove any planktonic bacteria. Excess PBS was drained from the disc by touching to sterile filter paper and the discs were transferred to sterile 1.5-ml microtubes containing 1 ml of PBS (pH 7.4) for enumeration of bacteria within biofilms formed on the discs. The microtubes were vortexed for 1 min at 2500 rpm to separate the adherent cells from the biofilm matrix and cellulose support. This method was determined by preliminary experiments to yield the maximum number of colony-forming units (CFU) adhering to cellulose discs. Disaggregated bacterial CFU per disc were then enumerated by 10-fold serial dilution in PBS (pH 7.4) and plating onto LB plates. To confirm complete recovery of the biofilm-associated bacteria from each disc, the discs were placed into new tubes containing PBS and the vortexing process was repeated (three steps). No CFU were recovered from plating of the PBS (data not shown), indicating the efficacy of the recovery protocol. Experiments were conducted in triplicate by inoculating three separate discs per treatment with the inoculum prepared from each culture.

Scanning electron microscopy (SEM). P. aeruginosa and S. aureus biofilms were established on cellulose discs as described above. The cellulose discs were prepared for scanning electron microscopy (SEM) by standard techniques. After 24 h incubation, each cellulose disc and any adherent bacteria were fixed with 2% (w/v) glutaraldehyde in filter-sterilized 0.05 M PBS (pH 7.4) at room temperature for 16 h and then rinsed 3 times for 15 min each in 0.05 M PBS (pH 7.4). The fixed cellulose discs were then dehydrated in successive ethanol-water mixtures with increasing ethanol concentrations (20%, 40% 60%, 80%, and 95% v/v) for 15 min each and then twice in absolute ethanol for 15 min. The ethanol-dehydrated samples were then placed in an absolute ethanol bath, which was placed in a critical point drying device. The ethanol was replaced by successive additions of liquid carbon dioxide. Once the liquid CO₂ had replaced the ethanol, the chamber was heated under pressure to reach the critical evaporation point of carbon dioxide. The chamber was then slowly vented of gaseous CO₂ and the dry samples were removed. The dried samples were affixed to aluminum mounts with double-sided carbon adhesive tape and sputter-coated with platinum and palladium to a thickness of 18 nm. Observations were performed at 6-7 kV with a scanning electron microscope (Hitachi S-570, Japan). Five fields of view at magnifications from 1500× were taken at randomly chosen areas from the optic surface of each sample. Each experiment was conducted in triplicate. A biofilm-positive field was defined as being occupied by biofilm over at least half of the visible area. If no biofilm, or scant numbers of cells were seen, examination was then carried out at 5000×.

Assessing the stability of Se-MAP coating on cellulose discs. The stability of selenium on the Se-MAP-coated cellulose discs was tested in the following manner. Discs were coated with Se-MAP as described, except that after washing twice in PBS (pH 7.4), the discs were placed in glass tubes containing 10 ml of PBS (pH 7.4) and the tubes were held at room temperature for 1 week. The discs were then dried, sterilized with 70% ethanol, and dried again. GSH (300 μM) was added to each disc and the discs were used in the colony biofilm assay.

### Results for Example 5

Selenium in Se-MAP bound to cellulose discs produces superoxide radicals. To confirm both the presence and function of selenium on the Se-MAP-coated cellulose discs, the generation of the superoxide radical (O₂.⁻) by selenium was measured using a lucigenin-enhanced CL assay. Diselenides, such as diselenocystines, are reduced by thiols forming the selenide anion, RSe⁻. Thiols are compounds that contain a functional group composed of a sulfur atom and a hydrogen atom (—SH), also known as a sulfhydryl group. The catalytic selenide anion, RSe⁻ reacts with oxygen to form O₂.⁻ and a putative thiyl radical R—Se., which reacts with two moles of thiol (supplied in the assay as glutathione (GSH)) to regenerate the original selenide anion as shown in the equations below:

RSeS—R′+2GSH→2RSe⁻+GSSG′

RSe⁻+2O₂→RSe.+2O₂.⁻

RSe.+2GSH→RSe⁻+GSSG′

The greater the selenide anion redox or catalytic activity, the greater the amount of O₂.⁻ produced in the radical generating system with a subsequently greater CL activity. An increase in CL confirmed the presence of functional selenium on the treated cellulose discs (FIG. 3). Further, the increase correlated with the increase of Se-MAP concentration on the cellulose discs (FIG. 3.).

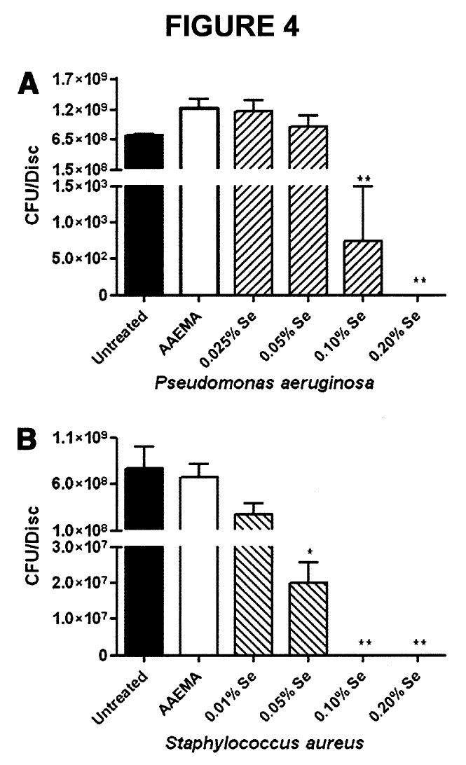

Selenium in Se-MAP bound to cellulose discs inhibits biofilm formation by P. aeruginosa and S. aureus. The ability of P. aeruginosa and S. aureus to form biofilms on uncoated cellulose discs and discs coated with AAEMA alone were examined in the colony biofilm assay. Biofilm formation was measured by determining the CFU adhering to the cellulose discs 24 h after inoculation. For P. aeruginosa, 7×10⁸ and 1×10⁹ CFU were recovered from untreated cellulose discs and AAEMA-coated discs, respectively (FIG. 4A), while approximately 7×10⁸ were recovered from the control discs for S. aureus (FIG. 4B).

The efficacy of different concentrations of selenium bound to cellulose discs as Se-MAP in inhibiting P. aeruginosa and S. aureus biofilms were then tested. Cellulose discs coated with 0.2%, 0.1%, 0.05% and 0.025% Se (as Se-MAP in AAEMA) were inoculated with P. aeruginosa as described in Materials and Methods. At 0.2% Se, total inhibition of biofilm formation was achieved (no CFU recovered), while 0.1% Se significantly (P<0.001) reduced the CFU of P. aeruginosa recovered from the cellulose discs (FIG. 4A). At 0.05% and 0.025% Se, no significant differences in the CFU of P. aeruginosa recovered from control discs and Se-MAP treated discs were observed (FIG. 4A). Inhibition of S. aureus was examined in the same way, except the lowest concentration tested was 0.01% Se. At a Se concentration of 0.1%, total inhibition of biofilm formation was observed, while at 0.05% Se, the number of CFU was significantly reduced (P<0.05) (FIG. 4B). However, at 0.01% Se, no significant difference was observed (FIG. 4B). The results indicate that relatively low concentrations of Se, 0.2% and 0.1%, are efficient in inhibiting biofilm formation by both P. aeruginosa and S. aureus.

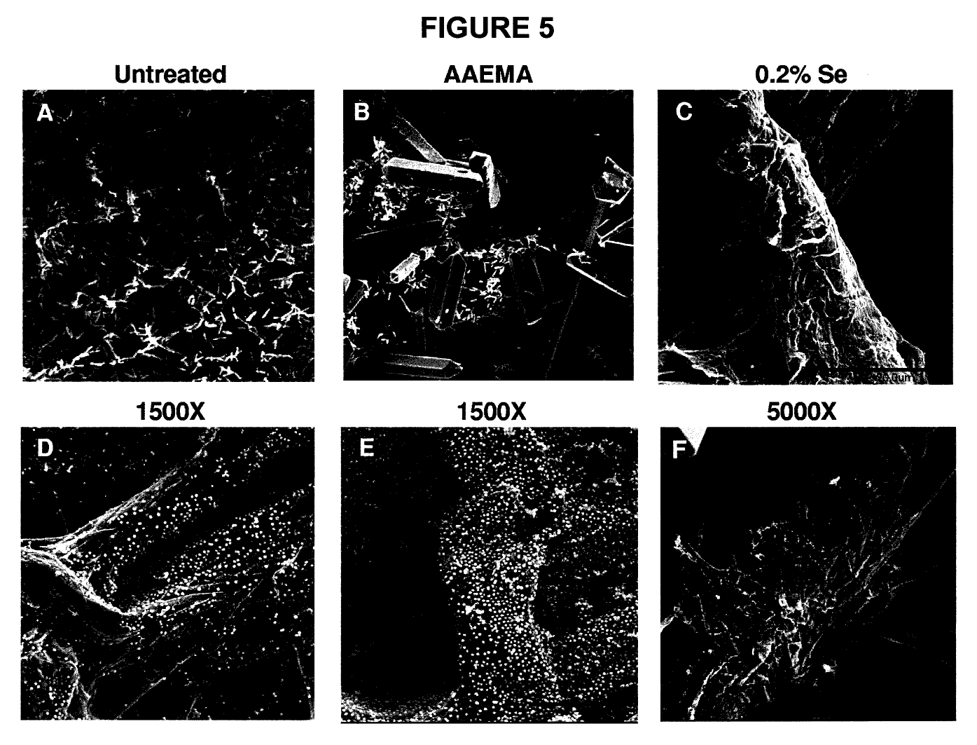

To confirm the results of the previous experiments, P. aeruginosa and S. aureus biofilm formation on uncoated, AAEMA-coated and Se-MAP-coated cellulose discs were analyzed by SEM. P. aeruginosa and S. aureus were inoculated onto the discs in the same manner as for the colony biofilm assay. On untreated discs and discs coated with AAEMA only, P. aeruginosa formed typical biofilms characterized by the presence of microcolonies (FIGS. 5A and B). Similar results were obtained with selenium concentrations of 0.01% (data not shown), while almost no bacteria were seen on the cellulose discs coated with 0.2% selenium (FIG. 5C). S. aureus formed evenly distributed sheets of bacteria on untreated discs and AAEMA-coated discs (FIGS. 5D and E). These sheets of bacteria were also present at 0.01% selenium (data not shown), but bacteria were only rarely seen when the discs were coated with 0.2% selenium (FIG. 5F).

The reduction in biofilm formation seen with both microorganisms is probably due to oxidative stress from the production of O₂. ⁻, and other reactive oxygen species, which may damage the bacterial cell walls as well as the DNA. Selenium acts as a catalytic generator of O₂.⁻ from the oxidation of thiols and thiol-containing compounds such as GSH, homocysteine, and Cys-Gly are present in human plasma. Therefore, GSH was used throughout the experiments to mimic the host environment. To determine if reduced thiols present in bacteria could activate Se-MAP, the inhibition of P. aeruginosa biofilm development was compared in the presence and absence of GSH. At 0.1% Se, the level of inhibition was approximately 3.5 logs greater with GSH than without (1.3×10⁵ versus 4.5×10⁸, respectively); however, at 0.2% Se the levels of inhibition were the same regardless of the presence of GSH (data not shown). Thus, at concentrations of 0.1% and lower, Se requires GSH supplementation to inhibit P. aeruginosa biofilm development efficiently.

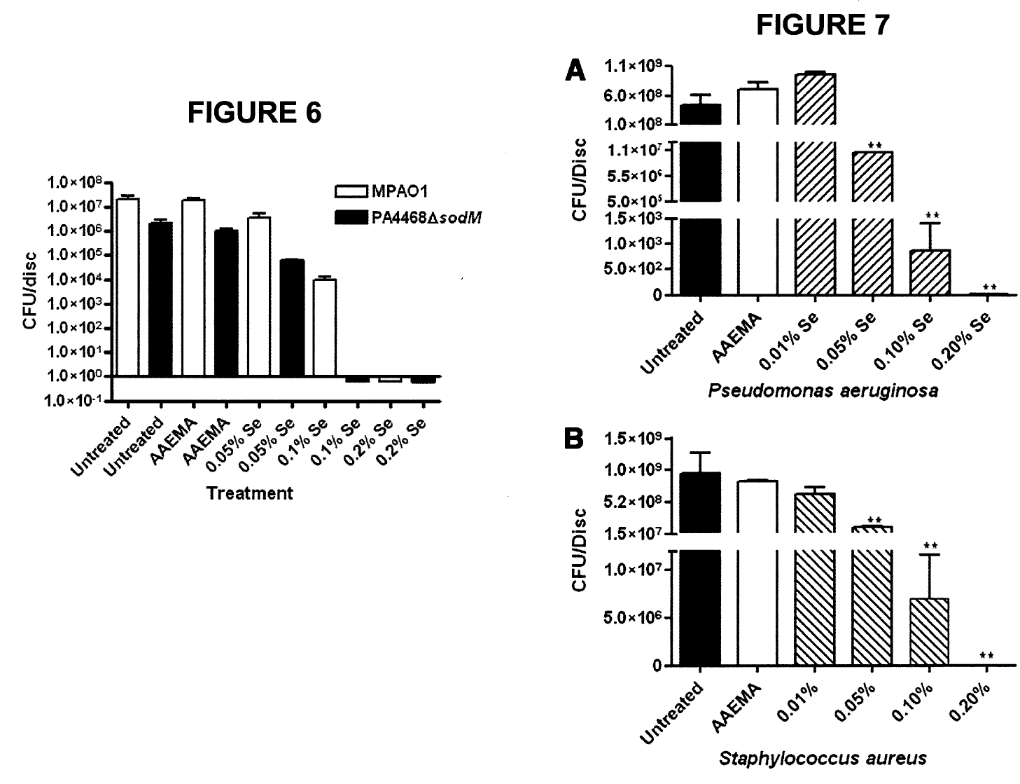

Based on their analysis in Escherichia coli, Bebien et al. (J. Bacteriol., 184:1556-1564 (2002)) suggested that, under aerobic conditions, resistance to selenium toxicity is due mainly to the function of superoxide dismutase. In comparison with their parent strain, E. coli mutants defective in the superoxide dismutase genes sodA and sodB were severely impaired in their tolerance to selenium. P. aeruginosa contains two superoxide dismutase genes, sodM (sodA) and sodB that are highly homologous to the E. coli sodA and sodB. The genes were isolated through the complementation analysis of an E. coli sodAB mutant. To determine if selenium affects the development of a PAO1 biofilm through superoxide dismutase, the P. aeruginosa strain PA4468ΔsodM, which carries defective sodM, was utilized. Since the development of P. aeruginosa biofilm was completely inhibited by 0.2% selenium but partially inhibited by 0.05 and 0.1% selenium (FIG. 4A), the effect of 0.05, 0.1, and 0.2% selenium on the development of biofilms by PA4468ΔsodM and its parent strain, MPAO1 were compared. On untreated as well as AAEMA-treated discs (controls), PA4468ΔsodM formed biofilm less efficiently than MPAO1, due to the differences in the growth rate between the two strains (FIG. 6). As previously demonstrated for the E. coli sodAB mutants, planktonic cells of PA4468ΔsodM grew more slowly than those of MPAO1 (data not shown). However, 0.05% selenium inhibited biofilm formation by PA4468ΔsodM more efficiently than MPAO1 biofilm (FIG. 6). More importantly, while 0.1% selenium partially interfered with the development of biofilm by MPAO1 (reducing the CFU/disc from 1.9×10⁷ to 9.2×10³), it almost prevented the development of PA4468ΔsodM biofilm (reducing the CFU/disc from 7.1×10⁴ to 0.6×10⁻¹) (FIG. 6). These results demonstrate that aerobically, selenium produces much of its inhibitory effect on P. aeruginosa biofilm formation through superoxide dismutase.

Se-MAP remains bound to cellulose discs in aqueous solution. To determine whether Se-MAP bound to cellulose discs remains stable when in prolonged contact with aqueous environments, Se-MAP-coated discs were soaked in 10 ml of PBS (pH 7.4) at room temperature for seven days. The discs were dried and their effectiveness in inhibiting biofilm formation by P. aeruginosa and S. aureus was determined as described above. As shown in FIG. 7, cellulose discs coated with Se-MAP retained their biofilm-inhibitory activity against P. aeruginosa and S. aureus. Total inhibition of biofilm formation was seen at 0.2% Se-MAP for both P. aeruginosa and S. aureus whereas partial inhibition was seen at 0.1% Se-MAP for both microorganisms. The overall effect of incubation in PBS for one week on the anti-biofilm activity of the discs was minimal. This indicates that use of Se-MAP coated cellulose gauze would be suitable for long-term dressing of wounds.

The paradox of selenium (Se) is that it is both essential and toxic. According to the World Health Organization, the recommended daily dietary selenium intake is 40 μg Se/day. While high blood levels of selenium (greater than 1000 μg/L) can result in selenosis, selenium is not toxic at high levels of dietary intake (3,200 μg/day). To check for the possibility that selenium leaching from the Se-MAP treated cellulose discs could have reached a toxic level, the effect of the PBS solution in which the discs were soaked was examined by a commercial testing laboratory (Toxikon, Bedford, Mass.). None of the solutions was found to be cytotoxic on monolayers of L929 mouse fibroblast cells in the agar diffusion test (data not shown).

Conclusion for Example 5. The results of these experiments point out several important points regarding the clinical application of this organo-selenium acrylate polymer a potential wound dressing: (1) a low percentage (0.2%) selenium coating was effective in preventing P. aeruginosa or of S. aureus from establishing biofilms on cellulose; (2) cytotoxicity analysis confirmed that the amount of selenium that leached out of the cellulose over the course of one week, if any, was not cytotoxic against mammalian cells; and (3) the selenium coating was stable since incubation in PBS for a week showed little change in the selenium content or the antibacterial activity. Thus, the application of Se-MAP-coated gauze to the debrided tissues of burn wounds may prevent the development of biofilms and facilitate wound healing. Additionally, Se-MAP has the potential to block bacterial biofilm formation on many different kinds of surfaces besides wound dressings, such as tampons, catheters, or any other surface where bacterial biofilms are a medical problem.

### Example 6

### Selenium Content and Superoxide Activity Analysis for Polyurethane Bandage Coating

Bacteria Inhibition Assays on Polyurethane Pieces: The purpose of this example was to determine the colony forming units of Pseudomonas aeruginosa 6294 or Staphylococcus aureus 31 adheres on control and selenium treated polyurethane pieces. This example describes the procedure to determine whether the selenium labeled polyurethane inhibits Staphylococcus aureus 31 adhesion and growth on the surface better than untreated polyurethane.

Materials and Methods: 1.9 mg N—N′-Bis-steroyl selenocystamine was mixed into 1.5 mL of a 1:1 solution of Dimethylsulfoxide (DMSO) and 4-methyl-2-pentanone and stirred until dissolved (solution A). 1.7 grams of prepolymer was raised to 60° C. and allowed to melt. Solution A was added and stirred. 0.9 mL 4-methyl-m-phenylen diisocyanate was added while stirring. 100 uL ethylenediamine was added. The resulting solution was placed in a 60° C. oven for two days until product hardens. Regular sections of this material were then removed for testing by the Colony Forming Unit (CFU) assay.

Strains: Pseudomonas aeruginosa 6294 (isolated from microbial keratitis) and Staphylococcus aureus 31 (isolated from contact lens induced peripheral ulcer) were obtained from CRC, Australia.

The ability of P. aeruginosa and S. aureus to form biofilms on the selenium coated polyurethane discs (pieces) was quantified as follows. P. aeruginosa and S. aureus were grown overnight in LB broth at 37° C. with shaking. Overnight cultures were washed once with PBS (pH 7.4). Aliquots of fresh LB broth were inoculated with the washed cultures to an optical density (OD₆₀₀) of 0.02 at 600 nm and then regrown at 37° C. with shaking for 4 h to OD₆₀₀ 0.8-0.9. The regrown cultures were washed once with PBS and serially diluted in 10-fold steps to obtain a 1×10⁻⁵ dilution. Five-μl aliquots from the 10-5 dilution were added to selenium coated polyurethane discs and untreated polyurethane discs at various concentrations of selenium. The inoculated discs were placed on LB agar plates, and the plates were inverted and incubated at 37° C. for 24 hours.

Following incubation, each disc was gently washed twice with sterile PBS to remove any planktonic bacteria. Excess PBS was drained from the disc by touching to sterile filter paper and the discs were transferred to sterile 1.5-ml microtubes containing 1 ml of PBS for enumeration of bacteria within biofilms formed on the discs. To separate the adherent cells from the biofilm matrix and cellulose support, the microtubes were vortexed for 1 min at 2500 rpm, allowed to rest and vortexed again for a total of three vortexing steps. Disaggregated bacterial CFU per disc were then enumerated by 10-fold serial dilution in PBS and plating onto LB plates. To confirm complete recovery of the biofilm-associated bacteria from each disc, the discs were placed into new tubes containing PBS and the vortexing process was repeated (three steps). No CFU were recovered from plating of the PBS (data not shown), indicating the efficacy of our recovery protocol. Experiments were conducted in triplicate by inoculating three separate discs per treatment with the inoculum prepared from each culture.

Scanning electron microscopy (SEM). P. aeruginosa and S. aureus biofilms were established on polyurethane discs as described above. The discs were prepared for SEM by standard techniques (1, 4). After 24 h of incubation, each disc and any adherent bacteria were fixed with 2% (w/v) glutaraldehyde in filter-sterilized 0.05 M PBS (pH 7.4) at room temperature for 16 h and then rinsed 3 times for 15 min each in 0.05 M PBS. The fixed discs were then dehydrated in successive ethanol-water mixtures with increasing ethanol concentrations (20%, 40%, 60%, 80%, and 95% v/v) for 15 min each and then twice in absolute ethanol for 15 min. The ethanol-dehydrated samples were then placed in an absolute ethanol bath, which was placed in an EMS 850 Critical Point Drier (Electron Microscopy Sciences, Hatfield Pa.). The ethanol was replaced by successive additions of liquid carbon dioxide. Once the liquid CO₂ had replaced the ethanol, the chamber was heated under pressure to reach the critical evaporation point of carbon dioxide. The chamber was then slowly vented of gaseous CO₂ and the dry samples removed. The dried samples were affixed to aluminum mounts with double-sided carbon adhesive tape and sputter-coated with platinum and palladium to a thickness of 18 nm. Observations were performed at 6-7 kV with a scanning electron microscope (Hitachi 5-570, Japan). Five fields of view at magnifications from 1500× were taken at randomly chosen areas from the optic surface of each sample. Each experiment was conducted in triplicate. A biofilm-positive field was defined as being occupied by biofilm over at least half of the visible area. If no biofilm or only scant numbers of cells were seen, examination was then carried out at 5000×. All selenium coated discs showed no biofilm.

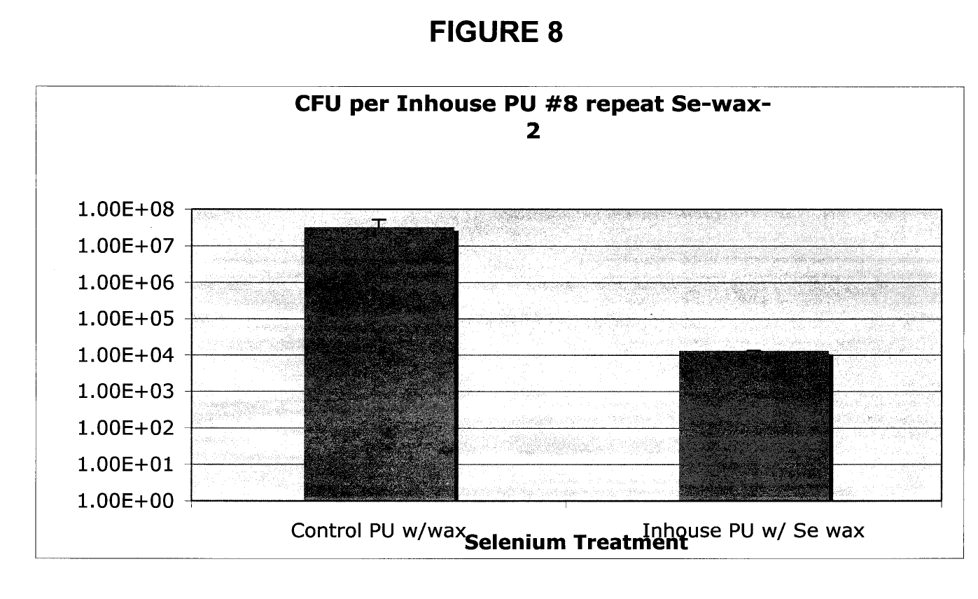

The data in Table V shows the actual data for 15 pieces of polyurethane coated with a selenium polymer. Only one out of the 15 pieces allowed any bacterial attachment at all. However, it should be noted that this one piece forces the data to give a very conservative result for the amount of inhibition of bacterial attachment. Thus, this one piece causes an average of three logs of inhibition rather than the seven logs of inhibition seen by the other 14 pieces. In the other data contained in this patent a conservative estimate was used. The data from Table V is presented in graphical form in FIG. 8.

TABLE V
CFU Per Polyurethane Piece.

| | Control PU | Selenium PU 8 |
|---|---|---|
| CFU per PU Piece | 1.00E+07 | 0.00E+00 |
| CFU per PU Piece | 3.00E+07 | 0.00E+00 |
| CFU per PU Piece | 5.00E+07 | 0.00E+00 |
| CFU per PU Piece | 1.00E+07 | 0.00E+00 |
| CFU per PU Piece | 3.00E+07 | 0.00E+00 |
| CFU per PU Piece | 3.00E+07 | 0.00E+00 |
| CFU per PU Piece | 3.00E+07 | 0.00E+00 |
| CFU per PU Piece | 3.00E+07 | 0.00E+00 |
| CFU per PU Piece | 5.00E+07 | 0.00E+00 |
| CFU per PU Piece | 8.00E+07 | 0.00E+00 |
| CFU per PU Piece | 2.00E+07 | 0.00E+00 |
| CFU per PU Piece | 2.00E+07 | 0.00E+00 |
| CFU per PU Piece | | 0.00E+00 |
| CFU per PU Piece | | 0.00E+00 |
| CFU per PU Piece | | 2.00E+05 |
| Average CFU per | 3.25E+07 | 1.33E+04 |
| Contact | | |
| Average STD | 1.38E+07 | 2.49E+04 |
| % inhibition | 0.00 | 99.96 |

Thus, in accordance with the present invention, there has been provided a method of producing selenium-based biocidal formulations that fully satisfies the objectives and advantages set forth hereinabove. Although the invention has been described in conjunction with the specific drawings, experimentation, results and language set forth hereinabove, it is evident that many alternatives, modifications, and variations will be apparent to those skilled in the art. Accordingly, it is intended to embrace all such alternatives, modifications and variations that fall within the spirit and broad scope of the invention.

What is claimed is:

1. A composition, comprising:
a solid substrate having a surface; and
a biocidal composition disposed on and attached to the surface of the solid substrate, the biocidal composition comprising:
a selenium compound selected from the group consisting of RSeH, RSeR′, RSeSeR, RSeSeR′, and RSeX, wherein each of R and R′ comprise an aliphatic or phenolic residue, and wherein X is a protecting group selected from the group consisting of a halogen, an imide, a cyanide, an azide, a phosphate, a sulfate, a nitrate, a carbonate, selenium dioxide, and combinations thereof;
an acrylate compound; and
wherein the selenium compound and the acrylate compound form an organoselenium-acrylate polymer whereby the acrylate compound interdigitates the selenium compound and permanently attaches the selenium compound to the surface of the solid substrate in a non-covalent manner.

2. The composition of claim 1, wherein the biocidal composition is effective against at least one of Staphylococcus aureus and Pseudomonas aeruginosa.

3. The composition of claim 2, wherein the biocidal composition prevents formation of bacterial biofilms on the solid substrate.

4. The composition of claim 1, wherein the selenium compound of the biocidal composition is present in a range of from about 0.01 μg to about 100 μg of elemental selenium per square centimeter of surface area.

5. The composition of claim 1, wherein the selenium compound of the biocidal composition comprises a formula selected from the group consisting of R—Se—CN, R—Se—Cl, R—Se—Br, R—Se-1, R—Se—N₃, R—Se—S—R, and R—Se—O—R.

6. The composition of claim 1, wherein the acrylate compound of the biocidal composition is a methacrylate compound.

7. The composition of 6, wherein the methacrylate compound is selected from the group consisting of 2-(Acetoacetoxy)ethylmethacrylate (AAEMA); butoxyethyl methacrylate (BEM); polymethyl methacrylate (PMMA); and combinations thereof.

8. A method of preventing growth of at least one of a living cell and a living organism on a solid substrate, comprising the steps of:
providing a solid substrate;
applying a polymer matrix comprising an effective amount of a biocidal composition to the solid substrate, wherein the biocidal composition comprises a selenium compound selected from the group consisting of RSeH, RSeR′, RSeSeR, RSeSeR′, and RSeX, wherein each of R and R′ comprise an aliphatic or phenolic residue, and wherein X is a protecting group selected from the group consisting of a halogen, an imide, a cyanide, an azide, a phosphate, a sulfate, a nitrate, a carbonate, selenium dioxide, and combinations thereof, and wherein the polymer matrix comprises an acrylate polymer, and wherein the selenium compound is non-covalently associated with the solid substrate via the polymer matrix; and
wherein when the biocidal composition comes into contact with a surface of the living cell and/or living organism, the selenium anion Se— and free radical species are generated, and wherein the selenium anion Se— remains attached to the surface of the solid substrate via the polymer matrix and the free radical species inhibits and/or inactivates said living cell and/or living organism, thereby preventing growth of the living cell and/or living organism on the solid substrate.

9. The method of claim 8 wherein the selenium compound is effective against at least one of Staphylococcus aureus and Pseudomonas aeruginosa.

10. The method of claim 8, wherein the selenium compound prevents formation of bacterial biofilms on the solid substrate.

11. The method of claim 8, wherein the selenium compound of the biocidal composition is present in a range of from about 0.01 μg to about 100 μg of elemental selenium per square centimeter of surface area.

12. The method of claim 8, wherein the selenium compound comprises a formula selected from the group consisting of R—Se—CN, R—Se—Cl, R—Se—Br, R—Se—I, R—Se—N₃, R—Se—S—R, and R—Se—O—R.

13. The method of claim 8, wherein the acrylate compound is a methacrylate compound.

14. The method of claim 13, wherein the methacrylate compound is selected from the group consisting of 2-(Acetoacetoxy)ethylmethacrylate (AAEMA); butoxyethyl methacrylate (BEM); polymethyl methacrylate (PMMA); and combinations thereof.

15. A method of treating or preventing the development or transmission of at least one undesired living cell and/or organism in or on a subject, comprising the steps of:
providing a subject;
providing a solid substrate having a polymer matrix disposed thereon, wherein the polymer matrix comprises an effective amount of a biocidal composition comprising a selenium compound selected from the group consisting of RSeH, RSeR′, RSeSeR, RSeSeR′, and RSeX, wherein each of R and R′ comprise an aliphatic or phenolic residue, and wherein X is a protecting group selected from the group consisting of a halogen, an imide, a cyanide, an azide, a phosphate, a sulfate, a nitrate, a carbonate, selenium dioxide, and combinations thereof, and wherein the polymer matrix comprises an acrylate compound, and wherein the selenium compound is non-covalently associated with the solid substrate via the polymer matrix; and
disposing the solid substrate in or on the subject to prevent the development or transmission of the undesired living cell and/or organism in or on a subject at the point at which the solid substrate comes into contact with the substrate.

16. The method of claim 15 wherein, in the step of providing a solid substrate, the solid substrate is selected from the group consisting of catheters, bandages, adhesive tapes, fabrics, fibers, plastics, cellulose pads, protein pads, carbohydrate pads, contact lenses, diapers, membranes, implants, and any other substrate having a surface on which bacterial biofilms may grow.
